(19) United States
(12) Patent Application Publication
(10) Pub. No.: US 2026/0037736 A1
(43) Pub. Date: Feb. 5, 2026

(54) SKILL-BASED AGENT OPERATION SYSTEM AND METHOD

(71) Applicant: RESEARCH & BUSINESS FOUNDATION SUNGKYUNKWAN UNIVERSITY, Suwon-si (KR)

(72) Inventors: Hong Uk WOO, Suwon-si (KR); Seung Hyun KIM, Suwon-si (KR); Sang Woo SHIN, Suwon-si (KR); Min Jong YOO, Suwon-si (KR); Dong Hoon KIM, Suwon-si (KR)

(21) Appl. No.: 19/285,823

(22) Filed: Jul. 30, 2025

(30) Foreign Application Priority Data
Aug. 2, 2024 (KR) 10-2024-0102839
Aug. 5, 2024 (KR) 10-2024-0104034

(51) Int. Cl. G06F 40/30; G06F 16/28

(52) U.S. Cl. CPC G06F 40/30; G06F 16/282

(57) ABSTRACT

According to an embodiment of the present invention, a skill-based agent operation system may comprise a skill grounding device configured to semantically interpret a user's natural language instruction and select one or more executable candidate skills among a plurality of skills, and a goal-conditioned policy learning device configured to construct a skill sequence for achieving a goal based on the selected skill, and to generate a goal-conditioned action policy by learning the constructed skill sequence based on reinforcement learning.

### CROSS-REFERENCE TO RELATED APPLICATIONS

This application claims the priority benefit of Korean Patent Application No. 10-2024-0102839 filed on Aug. 2, 2024 in the Korean Intellectual Property Office and Korean Patent Application No. 10-2024-0104034 filed on Aug. 5, 2024, in the Korean Intellectual Property Office, the disclosures of which are incorporated herein by reference.

### BACKGROUND

### 1. Field

The present disclosure relates to a skill-based agent operation system and method.

### 2. Description of the Related Art

With the advancement of artificial intelligence (AI) technology, the development of agents that perform specific goals based on a user's instruction is actively progressing. In particular, Embodied Instruction-Following (EIF) technology, which enables agents to perform continuous and long-horizon tasks in complex physical environments, is emerging as a core technology in various fields such as smart robots, virtual assistants, and industrial automation. EIF is defined as a series of processes involving the interpretation of the user's natural language instruction and the planning and execution of a series of tasks aligned with the instruction. These systems generally consist of three stages: instruction interpretation, task planning, and task execution.

Recently, a language model-based task planning technique has been attracting attention to more precisely interpret the user's natural language instruction and connect it to a skill, which serves as a unit for task execution. This technique is based on one or more pretrained language models, matching the given instruction to interpretable skills—such as semantic skills—and establishing a task execution plan through the matched skills. For example, a plurality of candidate skills may be extracted based on the user's instruction, and an appropriate skill is selected based on criteria such as executability or domain suitability, to construct an operation sequence.

However, conventional language model-based task planning technology often relies on skill data optimized for a specific domain, and therefore suffers from limited scalability and generality in new domains. That is, even when the same instruction is given, changes in the environment can often make it impossible to configure or execute the corresponding skill, which leads to a cross-domain instruction-following problem.

Meanwhile, Reinforcement Learning (RL) is a learning model in which an agent learns an optimal policy through rewards based on states and actions. In particular, goal-conditioned policy learning is known as an effective approach for learning an action sequence to achieve a given goal. However, this approach generally suffers from performance degradation in environments with reward sparsity. When rewards are provided only at the final state where the goal is achieved, the lack of clear guiding signals for selecting actions in intermediate stages makes it difficult to make strategic decisions for long-term goals. As a result, this leads to a reduction in learning efficiency and reliability.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

An object of the present invention is to provide a skill-based agent operation system and method capable of performing skill grounding to enable an agent to rapidly and reliably adapt previously learned skills, so that the agent can learn, infer, or process a given task even in a new domain previously unknown to the agent.

In addition, the present invention provides a skill-based agent operation system and method capable of performing skill-based goal-conditioned policy learning, which enables the agent to rapidly adapt to changes and robustly acquire processing results even when the long-term goal, short-term goal, or goal distribution changes in an environment where various goals can be provided.

According to an embodiment of the present invention, a skill-based agent operation system may comprise a skill grounding device configured to semantically interpret a user's natural language instruction and select one or more executable candidate skills among a plurality of skills, and a goal-conditioned policy learning device configured to construct a skill sequence for achieving a goal based on the selected skill, and to generate a goal-conditioned action policy by learning the constructed skill sequence based on reinforcement learning.

According to an embodiment, the skill grounding device may comprise: a skill generator configured to acquire an instruction and generate at least one skill according to the instruction, a skill determinator configured to determine whether the at least one skill is executable, and an instruction generator configured to generate a new instruction when it is determined that the skill is not executable, wherein the skill generator is further configured to generate at least one new skill based on the new instruction generated by the instruction generator.

According to an embodiment, the skill grounding device may further comprise: a hierarchical semantic skill database comprising at least one semantic skill, wherein the at least one semantic skill includes a lower-level skill and an upper-level skill that are hierarchically structured, and wherein the skill generator is configured to obtain at least one of an in-context example and a skill candidate group from the hierarchical semantic skill database, and to generate the at least one skill using the at least one of the in-context example and the skill candidate group.

According to an embodiment, the skill determinator may acquire environment information for a given environment using a visual-language model, and determine whether the skill is executable based on the environment information using a language model.

According to an embodiment, the instruction generator may generate the new instruction using low-level skill semantic information belonging to an original semantic skill candidate group.

According to an embodiment, the goal-conditioned policy learning device may comprise: a storage configured to store a sequence, and a processor configured to: determine at least one sub-goal corresponding to a final goal based on the sequence, acquire at least one skill corresponding to the sub-goal using an inverse skill-step dynamics model, and determine an action by decoding the at least one skill, wherein the inverse skill-step dynamics model comprises a model for inferring a skill based on a current situation and a next situation.

According to an embodiment, the processor may be further configured to: generate a new sequence based on the sequence stored in the storage, acquire the new sequence by sampling at least one sequence from the storage, select at least one branch state from the sampled sequence, acquire a skill corresponding to each of the at least one branch state using a skill prior distribution, acquire a latent space and a skill embedding based on at least one dynamics model, and acquire at least one new sequence by performing decoding based on the latent space and the skill embedding.

According to an embodiment, the at least one dynamics model may comprise a flat dynamics model for executing a skill under a single timestep to predict a state embedding for a next state in a current state, and the processor may perform model refinement by optimizing the state embedding, the flat dynamics model, and the skill-step dynamics model together.

According to an embodiment, the processor may comprise a skill encoder configured to encode all or a part of the sequence stored in the storage into a skill and obtain the skill prior distribution, and a skill decoder configured to decode the skill and infer the action.

According to an embodiment, the processor may be configured to train a skill-step dynamics model for inferring a next situation by combining a current situation and a skill, and the inverse skill-step dynamics model may be an inverse transformation of the skill-step dynamics model.

According to an embodiment of the present invention, a skill-based agent operation method may comprise acquiring an instruction and generating at least one skill according to the instruction, determining whether the at least one skill is executable, generating a new instruction when it is determined that the skill is not executable, and generating at least one new skill based on the new instruction.

According to an embodiment, the acquiring an instruction and generating at least one skill according to the instruction may comprise obtaining at least one of an in-context example and a skill candidate group from a hierarchical semantic skill database, and generating the at least one skill using the at least one of the in-context example and the skill candidate group, wherein the hierarchical semantic skill database comprises at least one semantic skill, and the at least one semantic skill includes a lower-level skill and an upper-level skill that are hierarchically configured.

According to an embodiment, the determining whether the at least one skill is executable may comprise acquiring environment information for a given environment using a visual-language model, and determining whether the skill is executable based on the environment information using a language model.

According to an embodiment, the generating at least one new skill based on the new instruction may comprise generating the new instruction using low-level skill semantic information belonging to an original semantic skill candidate group.

According to an embodiment, a skill-based agent operation method may comprise determining at least one sub-goal corresponding to a final goal based on the sequence, acquiring at least one skill corresponding to the sub-goal using an inverse skill-step dynamics model, and determining an action by decoding the at least one skill, wherein the inverse skill-step dynamics model comprises a model for inferring a skill based on a current situation and a next situation.

According to an embodiment, the skill-based agent operation method may further comprise generating a new sequence based on the sequence, wherein the generating a new sequence based on the sequence comprises acquiring the new sequence by sampling at least one sequence, selecting at least one branch state from the sampled sequence, acquiring a skill corresponding to each of the at least one branch state using a skill prior distribution, acquiring a latent space and a skill embedding based on at least one dynamics model, and acquiring at least one new sequence by performing decoding based on the latent space and the skill embedding.

According to an embodiment, the skill-based agent operation method may further comprise performing model refinement by optimizing the state embedding, the flat dynamics model, and a skill-step dynamics model together, and the flat dynamics model may comprise a dynamics model for executing a skill under a single timestep to predict a state embedding for a next state in a current state.

According to an embodiment, the skill-based agent operation method may further comprise encoding, by a skill encoder, all or a part of the sequence stored in the storage into a skill and obtaining the skill prior distribution, and decoding, by a skill decoder, the skill and inferring the action.

According to an embodiment, the skill-based agent operation method may further comprise training a skill-step dynamics model for inferring a next situation by combining a current situation and a skill, wherein the inverse skill-step dynamics model may be an inverse transformation of the skill-step dynamics model.

According to the above-described skill-based agent operation system and method, the agent is able to perform rapid and reliable adaptation of previously learned skills, thereby enabling it to learn, infer, or process complex tasks even in a new domain previously unknown to the agent.

According to the above-described skill-based agent operation system and method, the user's abstract instruction can be understood more quickly and accurately, thereby enabling more appropriate selection and determination of a skill or action for task execution.

According to the above-described skill-based agent operation system and method, it is possible to solve the problem of agent performance degradation that occurs when the agent is executed in a new domain not previously encountered during the learning process.

Accordingly, it becomes possible to more efficiently and optimally satisfy the requirements of an actual artificial intelligence model executed in various environments and domains.

According to the above-described skill-based agent operation system and method, even when the long-term goal, short-term goal, or goal distribution changes in an environment where a variety of goals may be given, the agent can quickly adapt to such changes and more robustly learn and acquire a policy without performance degradation.

According to the above-described skill-based agent operation system and method, the generalization performance of the trained policy can be improved by gradually expanding the dataset through generating a sequence (e.g., a path) toward a goal using skills, and by expanding the dataset through generating steps that were previously absent or consist of a mixture of multiple steps.

According to the above-described skill-based agent operation system and method, it has a high level of generalization performance, and when a modular structure is additionally applied, the model can quickly and reliably adapt to a changed goal, even when the goal distribution changes.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram of the skill grounding device according to an embodiment.

FIG. 2 is a diagram illustrating a hierarchical skill database according to an embodiment.

FIG. 3 is a chart illustrating the performance of the skill grounding device according to an embodiment under cross-domain settings.

FIG. 4 illustrates the performance of executable skill identification of the skill grounding device according to an embodiment.

FIG. 5 is a diagram illustrating the repetition performance of the skill grounding device according to the degree of domain shift.

FIG. 6 is a diagram illustrating the performance of the skill grounding device according to different skill hierarchy levels.

FIG. 7 is a diagram illustrating the performance of the skill grounding device according to the number of in-context examples.

FIG. 8 is a diagram illustrating the performance of the skill determinator according to an embodiment.

FIG. 9 is a diagram illustrating the performance of the above-described skill grounding device 10 according to the type of language model used.

FIG. 10 is a flowchart of a skill grounding method according to an embodiment.

FIG. 11 is a block diagram of a goal-conditioned policy learning device according to an embodiment.

FIG. 12 is a block diagram of a skill-step model processing unit 220 according to an embodiment.

FIG. 13A is a first diagram illustrating an example of sequence generation by a sequence generator according to an embodiment.

FIG. 13B is a second diagram illustrating an example of sequence generation by a sequence generator according to an embodiment.

FIG. 14 is a block diagram of a policy processor according to an embodiment.

FIG. 15 is a diagram for describing a learning operation of a goal-conditioned policy learning device according to an embodiment.

FIG. 16 is a block diagram of a zero-shot processing unit according to an embodiment.

FIG. 17 is a block diagram of a few-shot processing unit according to an embodiment.

FIG. 18 is a diagram illustrating the zero-shot evaluation performance of the goal-conditioned policy learning device according to an embodiment.

FIG. 19 is a diagram illustrating the few-shot evaluation performance of the same device.

FIG. 20 is a flowchart of a goal-conditioned policy learning method according to an embodiment.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The advantages and features of the present invention, and methods for achieving them, will become apparent with reference to the embodiments described below in conjunction with the accompanying drawings. However, the present invention is not limited to the embodiments disclosed herein and may be implemented in various different forms. The embodiments are provided merely to ensure the completeness of the disclosure of the present invention and to fully convey the scope of the invention to those of ordinary skill in the art to which the invention pertains. The present invention is defined only by the scope of the claims.

Terms used in the present specification will be briefly explained below, followed by a detailed description of the present invention.

The terms used in the present invention have been selected, to the extent possible, from widely used general terms in consideration of their functions within the invention; however, such terms may vary depending on the intent of those skilled in the art, judicial precedents, or the emergence of new technologies. In certain cases, terms arbitrarily selected by the applicant may also be used, and in such cases, the meanings thereof will be described in detail in the relevant portions of the description of the invention. Accordingly, the terms used in the present invention should not be interpreted merely by their literal names, but should be defined based on the meanings intended in the context of the invention as a whole.

Throughout the specification, when a certain part is described as “including” a certain component, it should be understood that, unless explicitly stated otherwise, the component does not exclude the presence of other components and may further include additional components. Also, the terms such as “unit,” “module,” and “block” used in the specification refer to units that process at least one function or operation, and may be implemented as hardware components such as software, FPGA, or ASIC, or as a combination of software and hardware. However, such terms are not limited to either software or hardware. The terms “unit,” “module,” and “block” may be configured to reside on an addressable storage medium or to be executed by one or more processors. Therefore, by way of example, the terms “unit,” “module,” and “block” may include software components, object-oriented software components, class components, and task components, as well as processes, functions, attributes, procedures, subroutines, segments of program code, drivers, firmware, microcode, circuitry, data, databases, data structures, tables, arrays, and variables.

Hereinafter, embodiments of the present invention will be described in detail with reference to the accompanying drawings so that those of ordinary skill in the art to which the invention pertains can readily implement the invention. In the drawings, parts that are not related to the description are omitted for clarity in explaining the present invention.

Terms including ordinals such as “first” and “second” may be used to describe various components, but the components are not limited by these terms. These terms are used solely to distinguish one component from another. For example, without departing from the scope of the present invention, a first component may be referred to as a second component, and similarly, a second component may be referred to as a first component. The term “and/or” includes a combination of a plurality of related items or any one of a plurality of related items.

Typically, an underscore (_) indicates that the character following it is a subscript of the character preceding it, and a caret (\hat{ }) indicates that the character following it is a superscript of the character preceding it. However, depending on the context, these symbols may also be used with different meanings (e.g., a caret used to denote a hat symbol on a specific character).

Hereinafter, the skill-based agent operation system and method according to the present invention will be described.

The present invention relates to a skill-based agent operation system and method, and more specifically, to an artificial intelligence system for operating an agent capable of understanding a user's natural language instruction and performing complex tasks based on the instruction. The system and method decompose and process task execution into skill units, thereby enabling the implementation of a highly versatile agent adaptable to various goals and environments. In particular, by separating the series of processes of understanding and executing instructions into two axes—skill selection and policy learning—it is possible to realize the integrated operation of natural language processing and reinforcement learning-based control.

The skill-based agent operation system may include a skill grounding device that receives and interprets a user's natural language instruction. The skill grounding device may semantically analyze the input instruction to determine the user's intent, and select one or more executable candidate skills suitable for the corresponding goal from among the skills that the agent can perform. The skill grounding device may play a key role in ensuring domain adaptability and instruction generalization capability, and may function as a preprocessing and initial decision-making layer of the overall system.

In addition, the skill-based agent operation system may include a goal-conditioned policy learning device configured to construct a skill sequence based on the selected executable candidate skills and train the sequence to achieve a goal. The goal-conditioned policy learning device generates a goal-conditioned action policy through reinforcement learning techniques and may perform effective policy learning by utilizing various models and techniques. The goal-conditioned policy learning device is designed to generate a robust policy, particularly in sparse reward environments or unseen situations, thereby enabling long-term goal achievement and high generalization performance.

### <Skill Grounding Device>

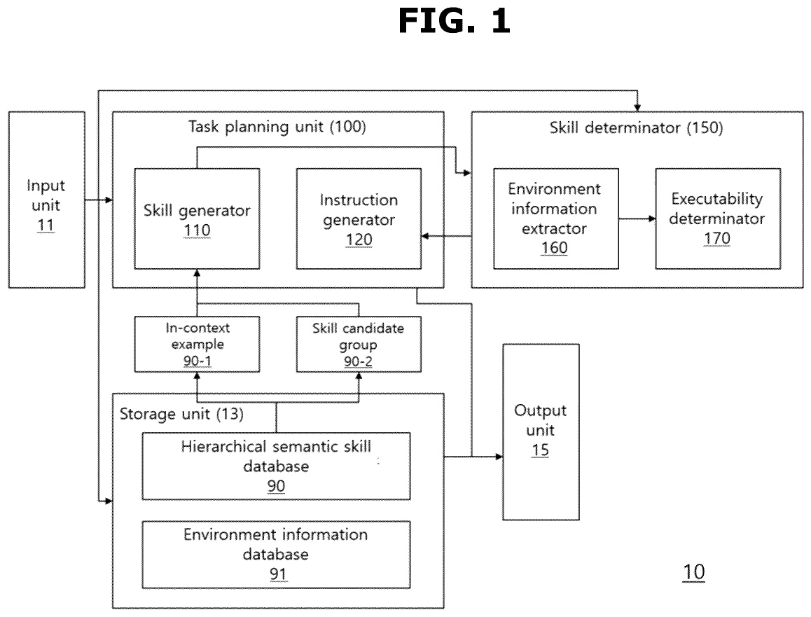

Hereinafter, an embodiment of the skill grounding device will be described with reference to FIGS. 1 to 9.

FIG. 1 is a block diagram of the skill grounding device according to an embodiment.

Referring to FIG. 1, the skill grounding device 10 may include an input unit 11, a storage unit 13, an output unit 15, a task planning unit 100, and a skill determinator 150. Here, at least two of the input unit 11, the storage unit 13, the output unit 15, the task planning unit 100, and the skill determinator 150 may be configured to transmit instructions or data unidirectionally or bidirectionally through a circuit, a cable, and/or wireless communication network technology. At least one of the input unit 11, the storage unit 13, and the output unit 15 may be omitted. In addition, according to an embodiment, the skill grounding device 10 may be implemented to include only one of the task planning unit 100 and the skill determinator 150.

The input unit 11 may receive data, instructions, and/or programs (which may be referred to as an app, application, or software) necessary for the operation of the skill grounding device 10 from a user, a designer, or another external device (e.g., an information processing device such as a smartphone or a desktop computer), and may transmit the received data, instructions, and/or programs to at least one of the storage unit 13, the task planning unit 100, and the skill determinator 150. For example, the input unit 11 may receive at least one skill for the generation or update of the hierarchical semantic skill database 90. As another example, the input unit 11 may receive an instruction from a user or designer. In this case, the instruction of the user or designer may be acquired in the form of text, image (including at least one of a still image and a moving image; hereinafter, the same unless otherwise specified), voice, and/or electrical signal. In addition, according to design, the input unit 11 may acquire information on the surrounding environment (i.e., observation information on the target domain) in the form of text, captured images, and/or recorded sounds, and transmit the information to the skill determinator 150. Furthermore, the input unit 11 may also receive an instruction for task determination. The input unit 11 may be implemented using, for example, a keyboard, mouse, tablet, touch screen, touch pad, scanner device, image capturing module, trackball, trackpad, ultrasonic scanner, motion detection sensor, vibration sensor, light receiving sensor, pressure sensor, infrared sensor, proximity sensor, microphone, data input/output terminal (e.g., a USB terminal or HDMI terminal), and/or a communication module (e.g., a LAN card, short-range communication module, or mobile communication module).

The storage unit 13 may store data or programs necessary for the skill grounding device 10, either temporarily or non-temporarily. For example, the storage unit 13 may store data or programs for the operation of at least one of the task planning unit 100 and the skill determinator 150. Here, the program may be directly written by a designer such as a programmer and stored in the storage unit 13, or may be transmitted from another physical recording medium (e.g., an external memory device or a compact disc (CD)), and/or may be acquired or updated via an electronic software distribution network accessible through a wired and/or wireless communication network. According to an embodiment, the storage unit 13 may include at least one of a register, a cache memory, a main memory, and a secondary storage device. These may be implemented based on a semiconductor device or a magnetic disk.

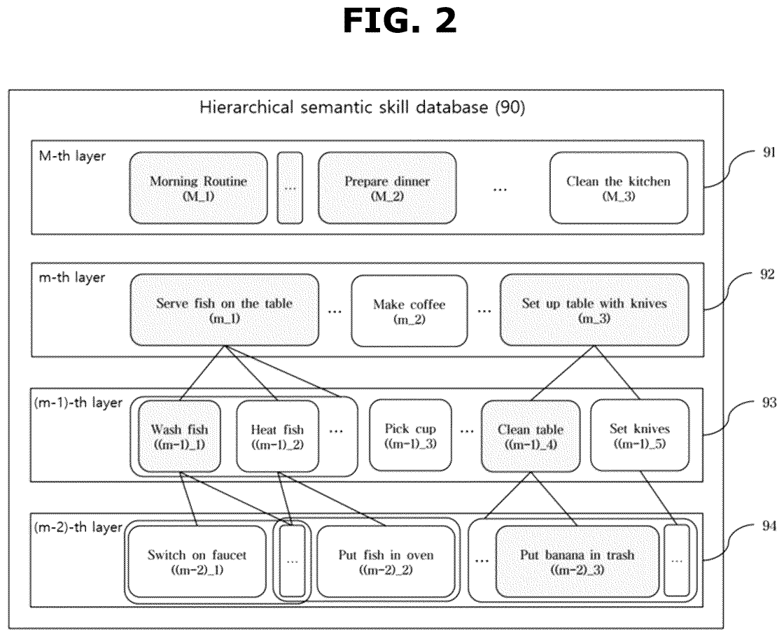

FIG. 2 is a diagram illustrating a hierarchical skill database according to an embodiment, and shows an example of a database constructed with skills for exemplary actions such as morning routine (M_1), meal preparation (M_2), or kitchen cleaning (M_3). In FIG. 2, gray blocks (M_1, M_2, (m−1)_1, etc.) represent skills that may be non-executable, and white blocks (M_3, m_2, (m−1)_2, etc.) represent skills that may be executable.

According to an embodiment, as illustrated in FIGS. 1 and 2, the storage unit 13 may include a hierarchical semantic skill database 90. The hierarchical semantic skill database 90 may be constructed to include at least one semantic skill (M_1 to M_3, m_1 to m_3, (m−1)_1 to (m−1)_5, and (m−2)_1 to (m_2)_3), where M and m are natural numbers equal to or greater than 1 and may be the same or different depending on the situation. The semantic skills may be classified and associated hierarchically. For example, the M-th layer may include relatively higher-level skills such as morning routine (M_1), evening preparation (M_2), and/or kitchen cleaning (M_3). The m-th layer, which is hierarchically lower than the M-th layer, may include sub-skills of the M-th layer skills, such as serving fish on the table (m_1), making coffee (m_2), and/or setting a knife on the table (m_3). Additionally, lower layers such as the (m−1)-th layer and the (m−2)-th layer may be further included. The (m−1)-th layer may contain lower-level skills of the m-th layer. For example, for the m-th layer skill serving fish on the table (m_1), the (m−1)-th layer may include washing fish ((m−1)_1) and heating fish ((m−1)_2). For the m-th layer skill making coffee (m_2), it may include picking up a cup ((m−1)_3). For the m-th layer skill setting a knife on the table (m_3), it may include cleaning the table ((m−1)_4) and placing the knife ((m−1)_5). The above-described skills (M_1 to M_3, m_1 to m_3, (m−1)_1 to (m−1)_5, (m−2)_1 to (m_2)_3) and hierarchical structure are exemplary. The hierarchical semantic skill database 90 may include the same or different number of skills and the same or different hierarchical structures depending on arbitrary selection or predefined settings by a user or designer. For instance, the hierarchical semantic skill database 90 may include fewer or more layers than the M-th layer, m-th layer, (m−1)-th layer, and (m−2)-th layer, and each layer may include more or fewer skills.

According to an embodiment, the hierarchical semantic skill database 90 may be constructed by including one or more skills (M_1 to M_3, m_1 to m_3, (m−1)_1 to (m−1)_5, (m−2)_1 to (m_2)_3), and may be built based on a structural approach to semantic skill training. For example, the hierarchical semantic skill database 90 may be constructed by collecting datasets for higher-level skills from datasets for lower-level skills using a bottom-up skill acquisition approach. More specifically, under a given environment, a predetermined learning model—such as Reinforcement Learning (RL) or imitation learning—may be used to acquire lower-level skills. Based on the acquired lower-level skills, a skill chain is generated to obtain relatively higher-level skills. Here, lower-level skills may include short-term and/or simple skills, whereas relatively higher-level skills may include long-term and/or complex skills. The process of generating skill chains from lower-level skills to acquire higher-level skills may be repeated one or more times. As a result, a set of skills organized into multiple hierarchical levels—namely, skill sets from the first layer to the M-th layer—may be constructed. Here, the first layer may correspond to the lowest-level skill set, and the M-th layer may correspond to the highest-level skill set. Through this iterative process, the hierarchical semantic skill database 90 covering skills from the bottom to the top layer may be constructed. This can be expressed by Equation 1 below.

$$\{ \begin{matrix}{Π}_{l}^{m} = \{ {π}_{l}^{( m , 1 )} , ⋯ , {π}_{l}^{( m , {N}_{m} )} \} \\ 𝒟 := \{ {e}^{( m , n )} : 1 \leq m \leq M , 1 \leq n \leq {N}_{m} \} \\ {e}^{( m , n )} := ( {l}^{( m , n )} , dn ( {e}^{( m , n )} ) , p ( {e}^{( m , n )} ) ) \\ {l}^{( m , n )} := Skill semantic of {π}_{l}^{( m , n )} \\ p ( {e}^{( m , n )} ) := ( {e}^{( m - 1 , {n}_{{j}_{1}} )} , ⋯ ) .\end{matrix} \qquad [ Equation 1 ]$$

In Equation 1, Π\hat{ }m_I denotes a skill set of the m-th layer, and π\hat{ }(m,n)_I denotes a skill belonging to the m-th layer. D represents the hierarchical semantic skill database 90. Each item (e\hat{ }(m,n)) in the hierarchical semantic skill database 90 may include at least one of the following: —semantic information I\hat{ }(m,n) for at least one skill π\hat{ }(m,n)_I; —the name(s) of detected object(s) dn(e\hat{ }(m,n)) collected during the training process of the n-th skill π\hat{ }(m,n)_I in the m-th layer; and—a one-step lower semantic skill plan p(e\hat{ }(m,n))=(e\hat{ }(m−1,n_j1), . . . ). Here, the skill π\hat{ }(m,n)_I may be acquired through chaining of lower-level skill(s) π\hat{ }(m−1,n_j1)_I, . . . as described above.

In an embodiment, the storage unit 13 may store an environment information database 91 for training the skill determinator 150. The environment information database 91 may be implemented by combining at least one of the object(s) observed and detected in the training environment, the names of the detected object(s), and the physical states of the detected object(s) at each time step t during the construction process of the entire skill set, for example, the skill sets from the 1st to the M-th layers. Here, the object(s) observed and detected in the training environment may be visually observed through, for example, an image capturing module, or may be observed through other devices such as a motion detection sensor. Meanwhile, the name (e.g., microwave oven) and/or physical state (e.g., closed state) of the detected object(s) may be obtained using, for example, an open-vocabulary detector adapted to the training environment. The open-vocabulary detector may be implemented based on a predetermined learning model (e.g., a transformer, a fast region-based convolutional neural network, or YOLO). The environment information database 91 may be expressed as Equation 2 below.

$$\{ \begin{matrix}{\prod }_{l}^{m} = \{ {π}_{l}^{( m , 1 )} , … , {π}_{l}^{( m , {N}_{m} )} \} \\ 𝒟 := \{ {e}^{( m , n )} : 1 \leq m \leq M , 1 \leq n \leq {N}_{m} \} \\ {e}^{( m , n )} := ( {l}^{( m , n )} , dn ( {e}^{( m , n )} ) , p ( {e}^{( m , n )} ) ) \\ {l}^{( m , n )} := Skill semantic of {π}_{l}^{( m , n )} \\ p ( {e}^{( m , n )} ) := ( {e}^{( m - 1 , {n}_{{j}_{1}} )} , … ) .\end{matrix} \qquad [ Equation 1 ]$$

In Equation 2, D_o denotes the environment information database 91, o\hat{ }(TR)_t represents the observation result (e.g., visual observation result) in a given environment (e.g., a training environment), dn(o\hat{ }(TR)_t) indicates the name(s) of the detected object(s) in that environment, and ds(o\hat{ }(TR)_t) represents the physical state(s) of the detected object(s). The variable t indicates each time step in the process of generating the skill set Π_I.

The output unit 15 may output and provide to the outside a processing result of at least one of the task planning unit 100 and the skill determinator 150 or data stored in the storage unit 13. For example, the output unit 15 may visually and/or audibly provide to a user the task processing plan, or related determinations or operations, determined by the task planning unit 100 and the skill determinator 150, and/or may transmit the same to another external device (e.g., a robot or an external memory device) through a wired or wireless communication network. As another example, the output unit 15 may output an electrical signal corresponding to a task processing plan, determination, or operation. In this case, the output electrical signal may be transmitted to other component(s) (e.g., a motor or actuator) provided in the skill grounding device 10 via a cable or circuit. Additionally, if the output unit 15 includes an actuator of a robot manipulator or a motor connected to a drive wheel of a mobile robot, the output unit 15 may directly perform an operation corresponding to the task processing plan or related determinations or operations. The output unit 15 may also output and provide, as needed, a graphic user interface for visual information presentation or instruction input, or output all or part of a program and/or instruction to the outside. According to an embodiment, the output unit 15 may include a display, a printer device, a speaker device, an image output terminal, a data input/output terminal, a motor, an actuator, and/or a communication module, but is not limited thereto.

The task planning unit 100 may determine a task to be performed under a given environment based on the hierarchical semantic skill database 90 of the storage unit 13, and to this end, may first generate at least one skill.

According to an embodiment, the task planning unit 100 may include a skill generator 110 for acquiring at least one skill (e.g., semantic skill) optimal for performing a task in response to a given user instruction, and an instruction generator 120 for converting a predetermined skill into a fine-grained instruction that can be executed.

The skill generator 110 may acquire at least one skill corresponding to a user instruction by using the user instruction, obtain at least one of an in-context example 90-1 and a skill candidate group 90-2, and generate a semantic skill that is most helpful for performing the task based on them. If necessary, the skill generator 110 may further generate a skill by combining the history of previous skill generation performed by the skill generator 110. For example, if the skill determinator 150 determines that a generated skill is non-executable, and in response, the instruction generator 120 generates a new instruction, then the skill generator 110 may generate a new skill according to the new instruction and further use the generation history of the previously determined non-executable skill. According to an embodiment, the skill generator 110 may use a predetermined language model to generate a semantic skill. Additionally, the skill generator 110 may generate a skill not only based on the user instruction, but also based on observation information in the target domain, or based solely on such observation information. In this case, the skill may be generated to conform to the task performance based on both the user instruction and the observation information in the target domain.

The in-context example 90-1 refers to example(s) of skills that have been empirically or logically applied to the same or similar instructions, and may be obtained by extraction based on the hierarchical structure in the hierarchical semantic skill database 90 stored in the storage unit 13. Such in-context example(s) 90-1 may include relatively lower skill(s) corresponding to the instructed task and the observed environment. For example, when the task is [serving fish (m_1) on the table], the in-context example(s) 90-1 may include lower-level skills such as fish washing ((m−1)_1), fish heating ((m−1)_2), and placing the fish on the table (not shown).

The skill candidate group 90-2 refers to a set of skill(s) suitable for a given task and corresponding to each of the division results of the given task. The skill candidate group 90-2 may be provided by including a skill corresponding to the given task and skills of one or more layers that are relatively lower than the corresponding skill. Here, the skill(s) of the relatively lower layer(s) may be determined based on the hierarchical structure of the hierarchical semantic skill database 90 described above. According to an embodiment, the skill candidate group 90-2 may be generated, in whole or in part, using at least one skill corresponding to the in-context example 90-1.

According to an embodiment, at least one of the skill(s) from the in-context examples 90-1 and the skill(s) from the skill candidate group 90-2 may be retrieved using a k-Nearest Neighbors (kNN) retriever. Specifically, the skill generator 110 may retrieve one or more skill(s) corresponding to k in-context examples 90-1 from the hierarchical semantic skill database 90 by applying the kNN retriever to the given instruction and the corresponding observation result (e.g., visual observation result). In the kNN-based retrieval process, the skill generator 110 combines the instruction and observation into a single query, computes similarity scores based on the query, selects the top-k items e\hat{ }(m,n) with the highest similarity scores, and uses the selected items to determine at least one of the in-context examples 90-1 or the skill candidate group 90-2. Specifically, the selected item(s) e\hat{ }(m,n) may be used as in-context examples 90-1 to represent a one-step lower-level subplan, or as skill candidate group 90-2 to represent one-step lower-level semantic skills. Through this selection of skills from in-context examples 90-1 and/or skill candidate group 90-2, the task planning unit 100 may enable effective application of semantic skills in cross-domain settings.

The above-described operation of the task planning unit 100 may be represented by Equations 3 and 4 below.

$${ϕ}_{G} : ( i , h , x ( i , {o}_{t} ) , c ( i , {o}_{t} ) ) ↦ \overline{l} ∈ c ( i , {o}_{t} ) \qquad [ Equation 3 ]$$

In Equation 3, φ_G denotes the operation of the task planning unit 100, i denotes the given instruction, h denotes the history of the generation of semantic information (represented as Ī, Bar I, a bar-over-I), and o_t denotes the observation result in the target environment. In addition, x(i, o_t) denotes the in-context examples 90-1, and c(i, o_t) denotes the skill candidate group 90-2. The I represents semantic information for a skill and is an element of the skill candidate group 90-2. In other words, Equation 3 indicates that the task planning unit 100 selects an appropriate skill I from among the candidate skills in the skill candidate group 90-2 (c(i, o_t)) based on the instruction i, the history h, the in-context examples (x(i, o_t)), and the skill candidate group (c(i, o_t)).

$$\{ \begin{matrix}e ( i , {o}_{t} ) = \{ ( {e}^{( {m}_{1} , {n}_{1} )} , … , {e}^{( {m}_{k} , {n}_{k} )} ) \} \\ x ( i , {o}_{t} ) = \{ ( {l}^{( {m}_{1} , {n}_{1} )} , pl ( {e}^{( {m}_{1} , {n}_{1} )} ) , … \} \\ c ( i , {o}_{t} ) = \{ {l}^{( {m}_{1} - 1 , {n}_{{j}_{1}} )} , … \}\end{matrix} \qquad [ Equation 4 ]$$

In Equation 4, e(i, o_t) denotes a set of the above-described items (e\hat{ }(m_k, n_k)). p_I(e (m_1, n_1)) may include semantic information related to the semantic skill plan p_I(e\hat{ }(m, n)). According to Equation 4, the in-context examples 90-1 (x(i, o_t)) may include semantic information I\hat{ }(m_1, n_1) for a skill at a certain layer m_1, and the skill candidate group 90-2 (c(i, o_t)) may include semantic information I\hat{ }(m_1-1, n_j1) corresponding to skills at a lower layer m_1-1 than the layer m_1 associated with the in-context examples.

In an embodiment, if the semantic information(s) (bar i) of the skill generated by the skill generator 110 is determined to be non-executable by the skill determinator 150 (to be described later), the instruction generator 120 may generate a new instruction i\hat{ }*. The new instruction i\hat{ }* may contain a more detailed and fine-grained directive for the corresponding skill. In this case, the instruction generator 120 may generate i\hat{ }* based on both the judgment result (i.e., the feedback) from the skill determinator 150 regarding the skill(s) generated by the skill generator 110 for executing the given instruction i (i.e., the user's natural language instruction), and the lower-level semantic information Lc(i, o_t) of the skill candidate group 90-2 (c(i, o_t)) as defined in Equation 4. The new instruction i\hat{ }* enables the skill grounding device 10 to determine and/or execute an action aligned with the user's intent by decomposing the original task into smaller and more tractable sub-tasks. The new instruction i\hat{ }* may replace the original user instruction i and trigger a new skill generation process by the skill generator 110, in accordance with Equation 3. Specifically, once the instruction generator 120 produces i\hat{ }*, the skill generator 110 receives i\hat{ }*, retrieves a new in-context example 90-1 from the environment information database 91 and/or a new skill candidate group 90-2, and re-generates semantic skills to perform the task. The newly generated skill(s) may then be re-evaluated by the performance determinator 170. The operation of the instruction generator 120 may be represented by Equation 5 below.

$$\{ \begin{matrix}{ϕ}_{R} : ( \overline{l} , f , 1 c ( i , {o}_{t} ) ) ↦ {i}^{*} \\ 1 c ( i , {o}_{t} ) = {⋃}_{j = 1}^{k} \{ {p}_{l} ( {e}^{i} ) : {e}^{i} ∈ p ( {e}^{( {m}_{j} , {n}_{j} )} ) \}\end{matrix} \qquad [ Equation 5 ]$$

In Equation 5, φ_R denotes the operation of the instruction generator 120, bar I represents a semantic skill, and f denotes the feedback result from the skill determinator 150. Lc(i, o_t) refers to the lower-level skill semantic information corresponding to the given instruction i and the observation o_t of the environment, and may be represented in the form of a transformation (or function). i\hat{ }* denotes the newly generated instruction. In addition, p_I( ) represents semantic information, and e′ includes at least one element that belongs to a lower-level semantic skill plan p(e\hat{ }(m,n))=(e\hat{ }(m−1, n_i1), . . . ).

The skill determinator 150 may determine the executability of the skill rr_bar I corresponding to the semantic information bar I of the skill acquired by the skill generator 110.

According to an embodiment, as illustrated in FIG. 1, the skill determinator 150 may include an environment information extractor 160 and an executability determinator 170.

The environment information extractor 160 may extract and identify environment information from a given environment o_t. Here, the environment information may include, for example, at least one of the name(s) of one or more object(s), denoted as dn(o_t), and their physical state(s), denoted as ds(o_t)). The environment information extractor 160 may extract such name(s) dn(o_t) and physical state(s) ds(o_t) using a visual-language model (VLM). A visual-language model refers to a model trained to process visual data (e.g., still images and/or videos) combined with natural language, capable of operations such as detecting objects from visual input and generating corresponding object names. The VLM may be fine-tuned using the environment information database 91 according to an embodiment. More specifically, the VLM may first segment and extract portions corresponding to objects from given environmental data (e.g., captured images) based on the environment information database 91, and then be trained to recognize object states using the extracted segments. The VLM may also be trained to generate questions about the object states (e.g., whether a door is open) and to answer those questions accordingly. Examples of the VLM include InstructBLIP (Instruction-based Bidirectional Language—Image Pretraining), CLIP (Contrastive Language—Image Pretraining), and/or VQA (Visual Question Answering), but the VLM is not limited thereto.

The executability determinator 170 may determine whether the skill π_I is executable based on the environment information identified and inferred by the environment information extractor 160. In this case, the executability determinator 170 may determine the executability of the skill using at least one language model. The at least one language model may include, for example, GPT (Generative Pre-trained Transformer), BERT (Bidirectional Encoder Representations from Transformers), RoBERTa (A Robustly Optimized BERT Pretraining Approach), LLaMA-2-70B (Large Language Model Meta Al-2-70B), and/or PaLM (Pathways Language Model), but is not limited thereto. The result of determining the executability of the skill may be transmitted to the instruction generator 120.

According to an embodiment, if the executability determinator 170 determines that the skill π_I generated by the skill generator 110 is not executable, it may transmit the information about the non-executable skill to the instruction generator 120. In response to receiving the information about the non-executable skill, the instruction generator 120 may obtain a new instruction i\hat{ }* to generate a skill candidate at a lower level (i.e., a more fine-grained level), as described above, and the skill generator 110 may acquire a new skill based on the new instruction i\hat{ }*. If the skill π_I generated by the skill generator 110 is determined to be executable, the executability determinator 170 may transmit the information about the executable skill to the task planning unit 100, and the task planning unit 100 may allow an operation to be performed according to at least one skill π_I based on the determination result of the executability determinator 170. For example, the skill grounding device 10 may operate based on one or more skills π_I generated by the task planning unit 100 and/or may output at least one skill π_I to the outside via the output unit 15 to provide it to a user or another device. In other words, if the skill is evaluated to be executable, it may be performed as is.

The operation of the skill determinator 150 described above may be represented by Equations 6 and 7 below.

$$ψ : ( {o}_{i} , \overline{l} ) ↦ c ∈ \{ E , ( NE , f ) \} \qquad [ Equation 6 ]$$

In Equation 6, y represents the operation of the skill determinator 150. o_t and Ī respectively denote the observation of the environment and the semantic information of the skill. c indicates the judgment result, where E means that the skill is executable, and NE means that it is not executable. The element NE indicating non-executability is output together with the feedback f.

$$\{ \begin{matrix}ψ = {ψ}_{LM} ∘ {ψ}_{VLM} : ( {o}_{t} , \overline{l} ) ↦ \{ E , ( NE , f ) \} \\ {ψ}_{VLM} : {o}_{i} ↦ ( dn ( {o}_{t} ) , ds ( {o}_{t} ) ) \\ {ψ}_{LM} : ( \overline{l} , dn ( {o}_{t} ) , ds ( {o}_{t} ) ) ↦ \{ E , ( NE , f ) \}\end{matrix} \qquad [ Equation 7 ]$$

In Equation 7, ψ_LM denotes the operation of the executability determinator 170, and ψ_VLM denotes the operation of the environment information extractor 160. As described above, Ī represents the semantic information of a skill, and dn(o_t) and ds(o_t) respectively denote the name(s) and physical state(s) of object(s).

According to an embodiment, at least one of the task planning unit 100 and the skill determinator 150 described above may be configured to perform the above-described task planning and/or skill determination by executing a program stored in the storage unit 15.

According to an embodiment, the above-described task planning unit 100 and the skill determinator 150 may be implemented individually or in combination by one or more processing devices. The one or more processing devices may include, for example, a Central Processing Unit (CPU), a Graphics Processing Unit (GPU), a Microcontroller Unit (MCU), an Application Processor (AP), an Electronic Control Unit (ECU), a Microprocessor (Micom), a Tensor Processing Unit (TPU), a Field-Programmable Gate Array (FPGA), an Application-Specific Integrated Circuit (ASIC), a neuromorphic chip, an embedded processor, hardware control logic, a hardware Finite State Machine (FSM), and/or at least one other electronic device capable of performing computation and control operations. These processing or control units may be implemented using one or more semiconductor chips, circuits, or related components, either alone or in combination.

According to an embodiment, the task planning unit 100 and the skill determinator 150 may be logically separated, in which case they may be implemented by a single information processing device. According to another embodiment, the task planning unit 100 and the skill determinator 150 may be physically separated, in which case they may be implemented by two or more homogeneous or heterogeneous information processing devices that are mutually independent. For example, the task planning unit 100 and the skill determinator 150 may be implemented by a single processing device (e.g., a Central Processing Unit), or by two or more different processing devices (e.g., a Central Processing Unit and a Graphics Processing Unit). Additionally, depending on the situation, the task planning unit 100 and/or the skill determinator 150 may be implemented using two or more processing devices.

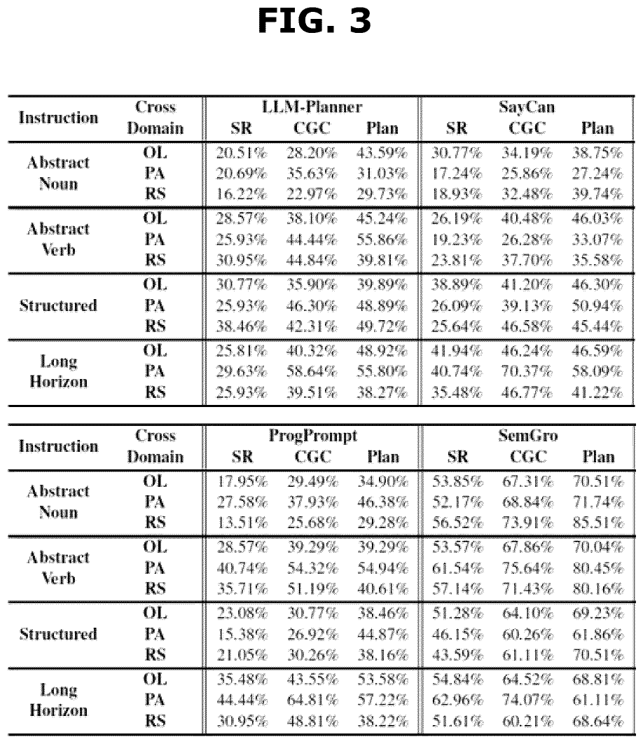

FIG. 3 is a chart illustrating the performance of the skill grounding device 10 according to an embodiment under cross-domain settings, specifically comparing its performance in VirtualHome against conventional methods. In FIG. 3, LLM-Planner, SayCan, and ProgPrompt refer to baseline models, while SemGro denotes the skill grounding device 10 of the proposed embodiment. OL, PA, and RS are scenarios corresponding to different domains: OL modifies object locations and relations compared to the training environment, PA changes the physical properties of objects, and RS alters visual content, object locations, and physical properties simultaneously. The success rate (SR), number of correctly grounded conditions (CGC), and plan accuracy (Plan) in FIG. 3 were measured using three different seeds for each cross-domain scenario.

Referring to FIG. 3, the skill grounding device 10 outperforms the baseline models (i.e., LLM-Planner, SayCan, and ProgPrompt) across all cross-domain scenarios. In particular, it shows improvements of 25.02% in success rate (SR) and 26.83% in correctly grounded conditions (CGC) compared to SayCan. It also achieves a 27.65% higher plan accuracy than LLM-Planner. Notably, in the PA cross-domain setting, the skill grounding device 10 achieves 61.11% plan accuracy, while its success rate (SR) and CGC reach 62.96% and 74.07%, respectively-exceeding the plan accuracy. This indicates that tasks requiring multi-step inference can still be completed through diverse sequences of semantic skills.

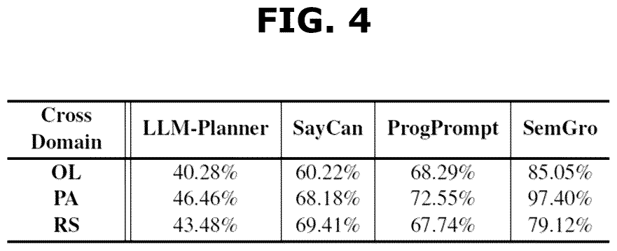

FIG. 4 illustrates the performance of executable skill identification of the skill grounding device according to an embodiment. The figure employs the Exec metric, which quantifies the proportion of executable skills within a given domain.

As shown in FIG. 4, the skill grounding device 10 outperforms the conventional ProgPrompt model by an average of approximately 17.99%. This demonstrates that the proposed device can effectively identify diverse conditions in cross-domain environments for skill grounding. This advantage stems from the use of a domain-agnostic visual-language model by the environment information extractor 160.

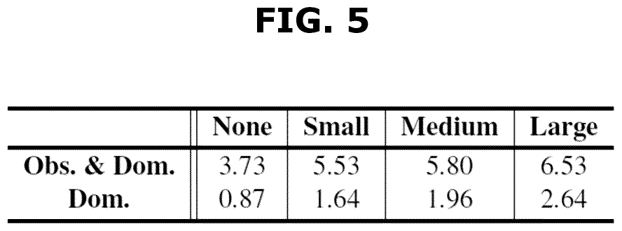

FIG. 5 is a diagram illustrating the repetition performance of the skill grounding device according to the degree of domain shift. In FIG. 5, “None” indicates the absence of domain shift, while “Small,” “Medium,” and “Large” correspond to relatively minor, moderate, and major shifts, respectively. “Obs. & Dom.” represents unexecutable skills, and “Dom.” denotes skills affected by domain differences. As shown in FIG. 5, there is a positive correlation between the degree of domain shift and the number of repetitions. In other words, the proposed skill grounding device 10 demonstrates robust performance in handling cross-domain environments with varying degrees of domain shift.

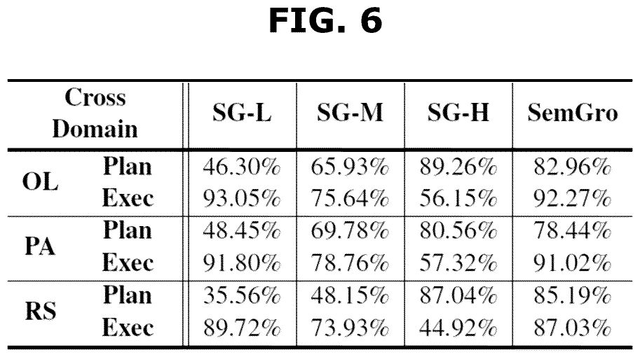

FIG. 6 is a diagram illustrating the performance of the skill grounding device according to different skill hierarchy levels. In FIG. 6, SG-L, SG-M, and SG-H indicate models that utilize low-level skills, mid-level skills, and high-level skills, respectively, in task planning.

Referring to FIG. 6, SG-L exhibits the lowest task planning accuracy (i.e., lower values for planning performance) but the highest skill executability (i.e., higher values for execution). This indicates that task planning performance is insufficient. In contrast, SG-H shows the highest planning accuracy, but the executability of the skills is extremely low-suggesting that the skills are nearly infeasible to execute. SG-M demonstrates moderate performance in both planning accuracy and skill executability, falling between SG-L and SG-H. However, unlike these baselines, the skill grounding device 10 adaptively identifies semantic information about skills at a mid-level of abstraction through iterative skill grounding. As a result, it not only improves task planning performance but also selects highly executable skills, thereby outperforming SG-L, SG-M, and SG-H in both planning and executability.

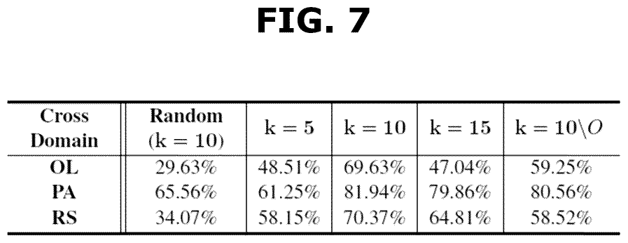

FIG. 7 is a diagram illustrating the performance of the skill grounding device according to the number of in-context examples. It shows the experimental results on how performance varies depending on the number of in-context examples used during task planning. Here, k refers to the number of in-context examples selected using the kNN retriever. Random indicates the case where 10 examples are randomly selected.

As shown in FIG. 7, when the number of in-context examples is 10, the planning accuracy is the highest. In other words, planning performance can be improved when the number of in-context examples is appropriate, but if it exceeds a certain threshold, further improvement cannot be achieved. This indicates that including skill candidates irrelevant to the task may degrade planning performance, and therefore, the number of in-context examples should be carefully selected.

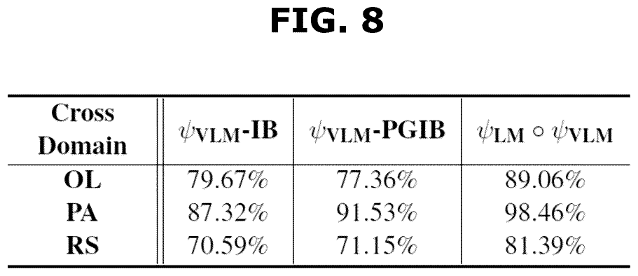

FIG. 8 is a diagram illustrating the performance of the skill determinator according to an embodiment. From left to right, it shows the performance in the following cases: when the skill determinator uses InstructBLIP as the visual-language model (VLM); when it uses PG-InstructBLIP, which is trained to understand the physical properties of objects, as the VLM; and when it uses a combination of the visual-language model and a language model.

Referring to FIG. 8, when both the visual-language model and the language model are used, execution performance improves by approximately 9.62% compared to using only a single visual-language model. This indicates that the addition of a language model can further enhance the capability of the visual-language model in determining the executability of semantic skills within a physical environment.

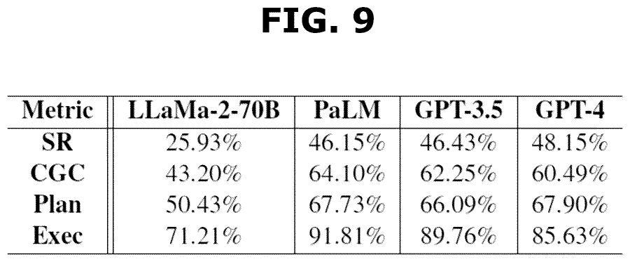

FIG. 9 is a diagram illustrating the performance of the above-described skill grounding device 10 according to the type of language model used. From left to right, the results show the performance when using LLaMA-2-70B, PaLM, GPT-3.5, and GPT-4.

Referring to FIG. 9, the skill grounding device 10 generally demonstrates strong performance across various language models, including PaLM, GPT-3.5, and GPT-4, but exhibits relatively lower performance with LLaMA-2-70B, which has comparatively fewer parameters.

The above-described skill grounding device 10 may be implemented using a device specifically designed to perform processing such as the aforementioned operations or controls, and/or by using at least one information processing device either alone or in combination. For example, the skill grounding device 10 may be implemented by combining two or more information processing devices. In this case, the task planning unit 100 may be implemented using at least one information processing device, and the skill determinator 150 may be implemented using at least one other information processing device physically separate from the one used for the task planning unit 100 (which may be of the same or a different type depending on the situation). The at least one information processing device may include, for example, a desktop computer, laptop computer, server hardware, smartphone, tablet PC, smartwatch, smart tag, smart band, head-mounted display (HMD) device, handheld game console, video recording device, navigation device, remote control device, digital television, set-top box, audio playback device (e.g., AI speaker), home appliances, manned or unmanned mobile objects (e.g., vehicles, mobile robots, wireless model vehicles, or robotic vacuum cleaners), manned or unmanned aerial vehicles (e.g., airplanes, helicopters, drones, model airplanes, or model helicopters), medical devices, industrial robots (e.g., robotic manipulators), machine tools, construction equipment, and the like, but is not limited thereto. Depending on the situation or conditions, a designer, user, or other party may also consider various devices—beyond those listed above—that are capable of processing and controlling information as suitable for implementing the skill grounding device 10.

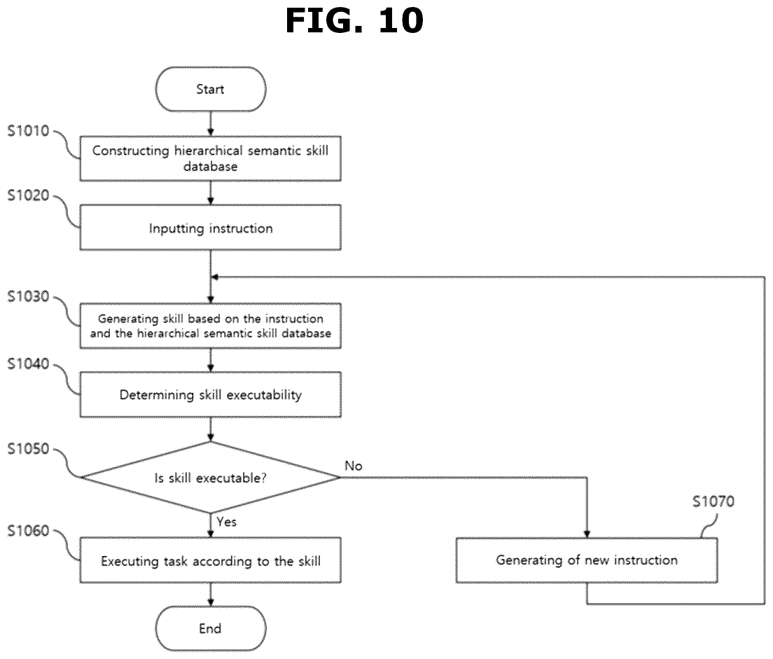

Hereinafter, an embodiment of a skill grounding method will be described with reference to FIG. 10.

FIG. 10 is a flowchart of a skill grounding method according to an embodiment.

Referring to FIG. 10, in an embodiment, the skill grounding method may include, as an initial step, constructing a hierarchical semantic skill database (S1000). The hierarchical semantic skill database is constructed to include at least one semantic skill, and within this database, each skill may be hierarchically classified. Accordingly, the hierarchical semantic skill database may include relatively higher-level skill(s) and relatively lower-level skill(s) associated with those higher-level skill(s). Here, the lower-level skills may include skills that are performed in a short period of time or through simple procedures, processes, or actions, whereas the relatively higher-level skills may include skills that are performed over a longer duration or through more complex procedures, processes, or actions. According to an embodiment, the hierarchical structure between lower-level and higher-level skills may be implemented through skill chain generation.

Subsequently, an indication may be obtained (S1010). The instruction may be input according to a user's manipulation or a predefined setting.

When an instruction is input, at least one skill corresponding to the instruction may be generated (S1020). Specifically, the generation of the skill may involve obtaining at least one of an in-context example and a skill candidate group from the hierarchical semantic skill database, and generating at least one skill based thereon. If necessary, a history of previous skill generations may also be used. The in-context example refers to example(s) of skills that have been empirically or logically applied to the same or similar instruction. The skill candidate group refers to a set of skills suitable for a given task and corresponding to each subtask resulting from the decomposition of the given task.

When at least one skill is generated, the executability of all or some of the skills may be determined (S1040). More specifically, environment information (e.g., the name and/or physical state of an object detected from an image of the environment) may first be extracted and identified in the given environment, and the executability of all or some of the skills may be determined based on the extracted environment information. The acquisition of environment information may be performed using a predetermined visual-language model. In addition, the determination of executability may be performed using a predetermined language model.

If it is determined that the skill is executable (YES in S1050), a task corresponding to the skill is executed (S1060). The task execution may be performed by at least one skill grounding device configured to perform the above-described processing, by at least one other device that receives data related to the skill from the skill grounding device, or by both.

Conversely, if it is determined that the skill is not executable (NO in S1050), a new instruction may be generated (S1070). The new instruction may include, for example, more detailed and fine-grained directions for the corresponding skill. According to one embodiment, the generation of the new instruction may be performed based on the semantic information of a lower-level skill included in the previously acquired skill candidate group.

When a new instruction is generated, at least one skill may be newly generated based on the new instruction (S1030). Subsequently, the executability of the newly generated skill(s) is determined again (S1040), and depending on the result of the executability determination (S1050), a task composed of the newly generated skill(s) may be performed (S1060), and/or another new instruction may be generated again (S1070). That is, if at least one newly generated skill is executable (YES in S1050), a task is executed based thereon (S1060), and if the newly generated skill(s) is still not executable (NO in S1050), a new instruction is generated again in response (S1070).

The above-described process may be repeatedly performed one or more times depending on the embodiment.

The skill grounding method according to the above-described embodiment may be implemented in the form of a program executable by a computer device. The program may include instructions, libraries, data files, and/or data structures, either individually or in combination, and may be designed and developed using machine code or high-level language code. The program may be specifically designed to implement the above-described method or may be implemented using various functions or definitions that are commonly known and available to those skilled in the field of computer software. The computer device may include, for example, a processor, memory, and optionally a communication device to support the execution of the program. A program for implementing the above-described skill grounding method may be recorded on a computer-readable storage medium. The computer-readable storage medium may include at least one type of physical storage medium capable of storing one or more programs temporarily or non-temporarily, such as: a semiconductor storage medium (e.g., ROM, RAM, SD card, or flash memory such as a solid-state drive (SSD)); a magnetic disk storage medium (e.g., a hard disk or floppy disk); an optical storage medium (e.g., a compact disc or DVD); or a magneto-optical storage medium (e.g., a floptical disk).

As described above, although an embodiment of the skill grounding device and the skill grounding method has been described, the skill grounding device or method is not limited to the embodiment described above. Various other devices or methods that may be modified or altered based on the foregoing embodiment by those of ordinary skill in the art may also fall within the scope of the embodiments of the skill grounding device or method. For example, even if the described method(s) are performed in a different order than described, and/or components of the described system, structure, device, or circuit are combined, connected, or arranged in a manner different from that described, or are replaced or substituted with other components or equivalents, such implementations may still be considered as embodiments of the skill grounding device and/or method described above.

It will be understood by those of ordinary skill in the art relevant to the embodiments of the present invention that various modifications can be made without departing from the essential characteristics of the present disclosure. Therefore, the disclosed methods should be interpreted as illustrative rather than limiting. The scope of the present invention is defined by the claims rather than the foregoing detailed description, and all differences falling within the equivalent scope of the claims should be construed as being included within the scope of the present invention.

### <Goal-Conditioned Policy Learning Device>

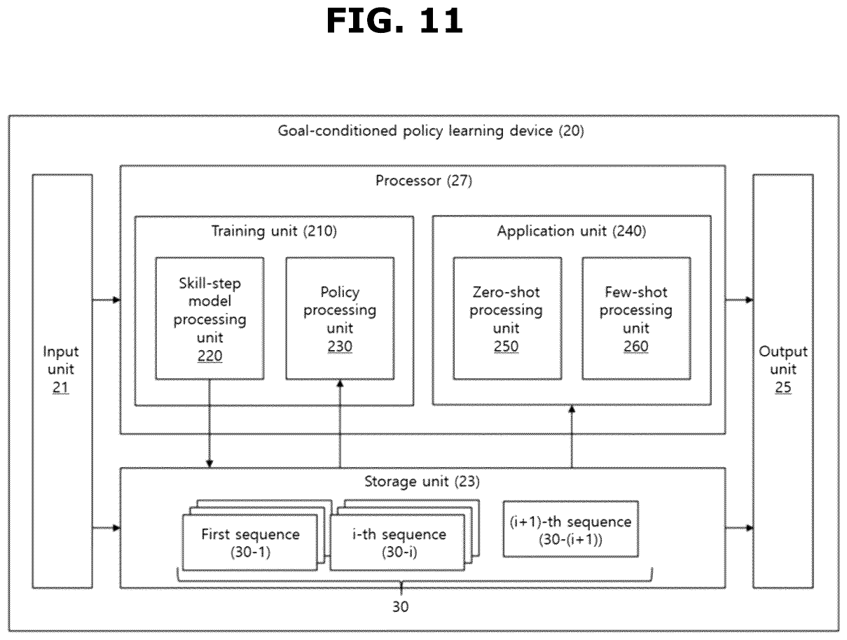

Hereinafter, an embodiment of a goal-conditioned policy learning device will be described with reference to FIGS. 11 to 17.

FIG. 11 is a block diagram of a goal-conditioned policy learning device according to an embodiment.

As illustrated in FIG. 11, the goal-conditioned policy learning device 20 (hereinafter referred to as the policy learning device) according to one embodiment may include an input unit 21, a processor 27, a storage unit 23, and an output unit 25. At least two of the input unit 21, the processor 27, the storage unit 23, and the output unit 25 may be configured to transmit data or commands/instructions unidirectionally or bidirectionally.

The input unit 21 may receive a dataset 30 required for learning, a program (which may be referred to as an app, application, or software) prepared for operating the processor 27, and/or commands or instructions related to the initiation of learning or inference from a user, and may transmit the same to at least one of the processor 27 and the storage unit 23. For example, the input unit 21 may receive at least one of the following: at least one goal, an environment associated with the goal, or a sequential process (i.e., an order or step) for achieving the goal. Here, the environment associated with the goal may include, for example, one or more maps (e.g., maps for indoor or outdoor environments), and the process for achieving the goal may include, for example, one or more sequences 30-1 to 30-i applicable to the map. The sequences 30-1 to 30-i may include, in order to achieve a specific goal, a series of actions executable sequentially or non-sequentially, outcomes of those actions, and various types of associated information. For instance, the sequences 30-1 to 30-i may include a path from one point to another (e.g., a movement path of a mobile robot) or a trajectory (e.g., the trajectory of a robot arm's end-effector). According to an embodiment, the input unit 21 may include, but is not limited to, a keyboard, mouse, tablet, touchpad, touchscreen, trackball, trackpad, scanner device, image capturing module, motion detection sensor, pressure sensor, proximity sensor, data input/output terminal, wired or wireless communication module, and/or a microphone.

According to an embodiment, the processor 27 may be configured to perform skill-based goal-conditioned policy learning based on a predetermined dataset 10, and/or obtain a result (e.g., a path) corresponding to given input data (e.g., at least one of a goal and an environment) based on a trained model. For example, the processor 27 may be configured to learn at least one skill for performing an action; generate a new sequence, i.e., the (i+1)-th sequence 30-(i+1), based on a predetermined sequence 30-1 to 30-i (where i is a natural number equal to or greater than 1); determine a sub-goal corresponding to a given goal; and/or determine a policy by selecting a skill appropriate for the sub-goal. In addition, the processor 27 may perform learning based on at least one of offline and online modes. For instance, the processor 27 may perform skill-based learning, including the generation of a new sequence 30-(i+1) by the training unit 210 in an offline manner, and may perform zero-shot learning or few-shot learning by the application unit 240 in an online manner. However, this is not limited thereto. The processor 27 may call and execute a program stored in the storage unit 23 to perform such operations.

The processor 27 may perform skill-based goal-conditioned policy learning using a predetermined learning model, according to an embodiment. The learning model may include, for example, at least one of a deep neural network (DNN), a convolutional neural network (CNN), a recurrent neural network (RNN), a deep Q-network (DQN), Q-learning, a transformer, a long short-term memory (LSTM), a multi-layer perceptron (MLP), a support vector machine (SVM), and/or a predetermined learning model that is a partial modification of the foregoing models. However, the present invention is not limited thereto.

The processor 27 according to an embodiment may include a central processing unit (CPU), a graphics processing unit (GPU), an application processor (AP), a microcontroller unit (MCU), an electronic control unit (ECU), a microprocessor (Micom), and/or at least one electronic device capable of performing various computation and control operations. These processing or control devices may be implemented using one or more semiconductor chips, circuits, or related components, either individually or in combination.

In an embodiment, as illustrated in FIG. 11, the processor 27 may include a training unit 210 and an application unit 240. Here, the training unit 210 and the application unit 240 may be logically and/or physically separated, depending on the embodiment. When logically separated, the training unit 210 and the application unit 240 may be implemented using a single processing device (e.g., a single central processing unit). When physically separated, the training unit 210 and the application unit 240 may be implemented using the same type of processing device (e.g., two or more central processing units) or different types of processing devices (e.g., one or more central processing units and one or more graphics processing units (GPUs)). In addition, according to an embodiment, either the training unit 210 or the application unit 240 may be omitted. In other words, the processor 27 may be implemented to include only the training unit 210 or only the application unit 240. In this case, the omitted unit may be implemented by another information processing device connected to the policy learning device 20 via a wired or wireless communication network. The policy learning device 20 may transmit the training or processing result of the training unit 210 to the other information processing device or receive the training or processing result from a training unit provided in the other information processing device.

According to an embodiment, the training unit 210 may include a skill-step model processing unit 220 configured to infer a skill corresponding to a given situation, determine a corresponding action, infer a distribution of skills for a given latent state, and generate a sequence based thereon; and a policy processing unit 230 configured to generate at least one goal (which may include at least one of a final goal and a sub-goal), obtain at least one skill corresponding to the generated goal(s), and determine a corresponding action based thereon. In addition, according to an embodiment, the application unit 240 may include at least one of a zero-shot processing unit 250 provided for zero-shot learning and a few-shot processing unit 260 provided for few-shot learning. That is, either the zero-shot processing unit 250 or the few-shot processing unit 260 may be omitted. Detailed descriptions of the training unit 210 and the application unit 240 will be provided later.

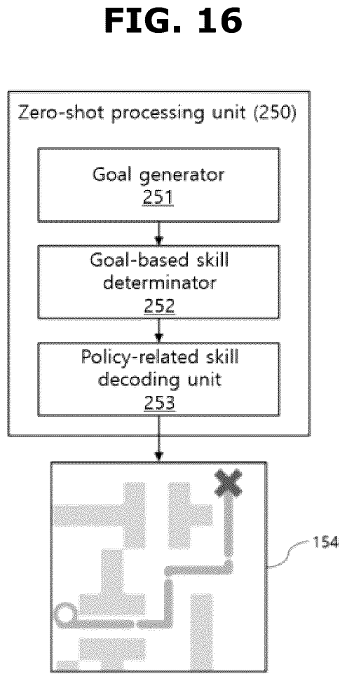

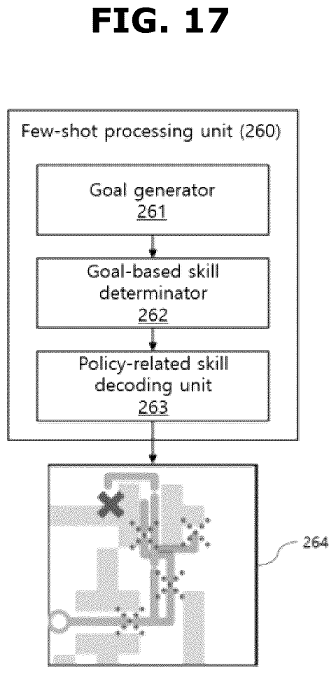

The storage unit 23 may temporarily or non-temporarily store various types of data necessary for the operation of the policy learning device 20, such as sequences 30-1 to 30-i, data generated by the processor 27 (e.g., newly generated sequence 30-(i+1)), and/or at least one program. The storage unit 23 may provide the stored data or instructions to the processor 27 upon request by the processor 27, or may transmit requested data (e.g., sequences 30-1 to 30-i and 30-(i+1)) or a sequence corresponding to a given goal (e.g., item 254 in FIG. 16, item 264 in FIG. 17, etc.) to the output unit 25, such that the output unit 25 provides the corresponding data to the user or to another device. The program stored in the storage unit 23 may be directly written or modified by a designer such as a programmer, may be received from another physical recording medium (e.g., an external memory device or a compact disc (CD)), and/or may be acquired or updated through an electronic software distribution network accessible via a wired or wireless communication network. According to an embodiment, the storage unit 23 may include at least one of a register, a cache memory, a main memory device, and an auxiliary memory device. These devices may be implemented using semiconductor components, magnetic disks, or the like.

The output unit 25 may be configured to output the processing results of the processor 27, data stored in the storage unit 23, or the like to an external destination. For example, the output unit 25 may output a sequence corresponding to a given goal (e.g., movement paths 254 and 264 to the given goal) and provide it to the user. Depending on the situation, the output unit 25 may directly provide such data to the user visually or audibly, or may transmit it to another electronic device (e.g., a mobile robot or vehicle) via a separate external memory device or through a wired or wireless communication network. The output unit 25 may include, for example, a display, a printer device, a speaker device, an image output terminal, a data input/output terminal, and/or a communication module, but is not limited thereto.

The above-described policy learning device 20 may be implemented using a specially designed device for performing operations or control as described above, using a single known information processing device alone, or using a combination of two or more information processing devices. These information processing devices may be of the same type or of different types. For example, the policy learning device 20 may include at least one information processing device used as the training unit 210 and at least one other information processing device used as the application unit 240, which is physically separated from the training unit 210 but communicatively connected thereto via a wired or wireless communication network. One or more information processing devices usable as the policy learning device 20 may be implemented using a predetermined device according to the situation, conditions, or selection of a user or designer. Examples include, but are not limited to: a desktop computer, a laptop computer, a server hardware device, a smartphone, a tablet PC, a smartwatch, a smart tag, a smart band, a head-mounted display (HMD), a portable gaming console, a navigation device, a video capturing device (e.g., camcorder, action camera), a scanner device, a smart key, a remote control device, a digital television, a set-top box, a sound output device (e.g., AI speaker), a home appliance, a manned or unmanned mobile unit (e.g., vehicle, robotic vacuum, or wireless model vehicle), a manned or unmanned aerial vehicle (e.g., airplane, helicopter, drone, model aircraft), a medical device, an industrial robot such as a robotic manipulator, a machine tool, a military robot, and/or a traffic controller. In addition to the above-mentioned devices, a designer or user may also consider at least one of various other devices capable of processing and controlling information as the goal-conditioned policy learning device 20, depending on the situation or conditions.

Hereinafter, functions and operations of the processor 27 will be described in more detail.

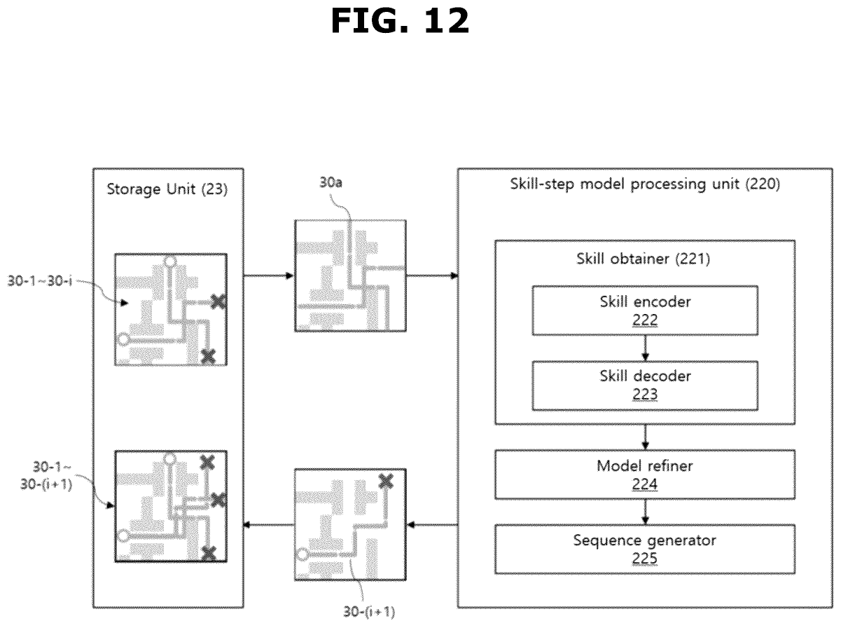

FIG. 12 is a block diagram of a skill-step model processing unit 220 according to an embodiment.

Referring to FIG. 12, the skill-step model processing unit 220 may receive at least one sequence 30a from among the plurality of sequences 30-1 to 30-i stored in the storage unit 23, generate at least one new sequence 30-(i+1) based on the received sequence(s), and transmit the generated sequence(s) to the storage unit 23. In this case, all sequences(for example, all paths) 30-1 to 30-i in the storage unit 23 may be transferred to the skill-step model processing unit 220. The storage unit 23 then stores a larger set of sequences 30-1 to 30-(i+1), including the newly generated sequence(s) 30-(i+1). In other words, the number of sequences 30-1 to 30-(i+1) increases.

According to an embodiment, the skill-step model processing unit 220 may include a skill obtainer 221, a model refiner 224, and a sequence generator 225.

The skill obtainer 221 may obtain one or more sequences 30a and acquire a series of actions corresponding thereto. The obtained sequence 30a may include all or part of at least one of the plurality of sequences 30-1 to 30-i stored in the storage unit 23. In this case, the skill obtainer 221 may learn a skill based on the given sequence 30a and may learn to determine actions based on the learned skill.

For skill learning and action determination, the skill obtainer 221 according to an embodiment may include a skill encoder 222 and a skill decoder 223.

The skill encoder 222 may encode all or part of a given sequence 30a into a skill, and the skill decoder 223 may obtain the skill from the skill encoder 222, acquire a state to be addressed (e.g., a current state), and decode the given state and skill to output an action corresponding to the state and skill. That is, the skill to be executed is inferred by the skill encoder 222, and the skill is converted into an actual action by the skill decoder 223.

In an embodiment, if a skill is an abstracted H-step consecutive action sequence and can be represented in a variational autoencoder (VAE)-based embedding space, the skill encoder 222 may obtain one or more skill embeddings z corresponding to at least one sequence 30a using a conditional-β-VAE network. In this case, as shown in Equation 8 below, the embedding vector z may be learned from an H-step sub-trajectory (τ\hat{ }sub) sub sampled from a given sequence 30a, for example, from the trajectory τ.

$${τ}_{t : t + H} = ( {s}_{t} , … , {s}_{t + H} , {a}_{t} , … , {a}_{t + H - 1} ) = ( {s}_{0 : H} , {a}_{0 : H - 1} ) \qquad [ Equation 8 ]$$

In Equation 8, s_i denotes a state at the time point i, and a_j denotes an action at the time point j.

In addition, the skill encoder 222 according to an embodiment may further obtain a skill prior distribution. The skill prior distribution refers to the distribution over skills that are likely to be executable in a specific state. By learning the skills that can be inferred from a specific state, it becomes possible to select a more appropriate skill under a given state. The acquired skill prior distribution may be used by the sequence generator 225 to generate a virtual path. In addition, according to an embodiment, the skill prior distribution may also be used by the application unit 240.

The model refiner 224 may refine a model to infer which skills are required to achieve a given purpose or at least one sub-purpose (subgoal, i.e., one or more purposes that must be achieved in advance to reach a final purpose). The model processed by the model refiner 224 may include, for example, at least one skill-step dynamics model P_θ. The skill-step dynamics model P_θ is a model designed to infer the next state by combining the current state and a skill (i.e., current state+skill→next state). According to an embodiment, the skill-step dynamics model P_θ may include at least one of a single-step dynamics model, a skill-step dynamics model, and an inverse skill-step dynamics model P\hat{ }-1_θ. Here, the single-step dynamics model is a dynamics model for predicting the state transition and change at each time step based on the current state and action; the skill-step dynamics model is a dynamics model for predicting state transitions and changes through the execution of skills performed over one or more time steps; and the inverse skill-step dynamics model P\hat{ }-1_θ may be a model for inferring the skill executed between a given state and a transitioned state. The inverse skill-step dynamics model P\hat{ }-1_θ may also be used to infer the skill between the initial latent state h_0 and the skill-step latent state h_H. Through the operation of the model refiner 224, the inferred skill can be conditioned on dynamics information. Such a skill-step dynamics model may be optimized through training to enhance the stability of virtual path generation by the sequence generator 225 and improve the performance of the policy processing. Further details will be described later.

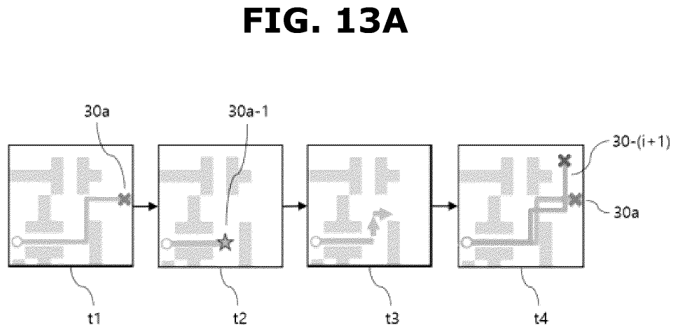

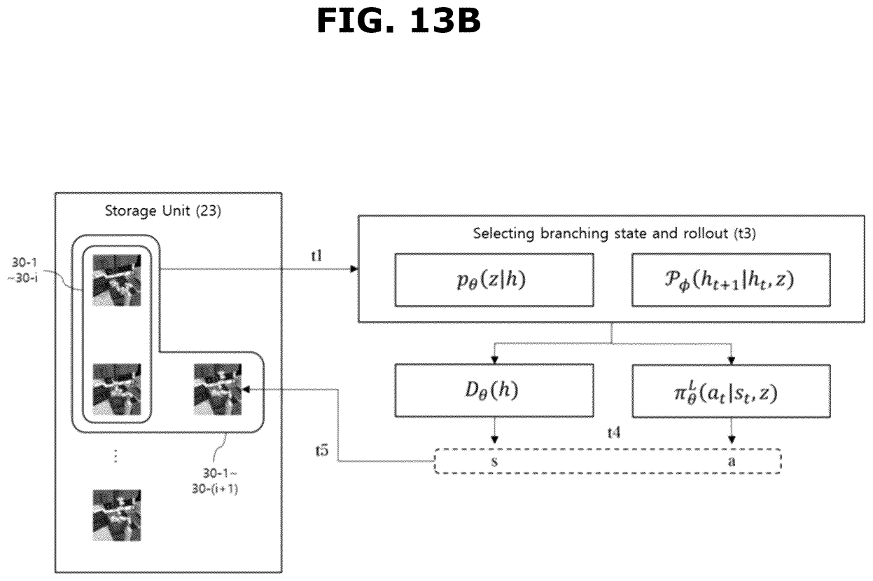

FIGS. 13A and 13B are first and second diagrams for describing an example of sequence generation by a sequence generator according to an embodiment.

As illustrated in FIGS. 13A and 13B, when a sequence 30a is given, the sequence generator 225 may generate a new sequence 30-(i+1) based on it. Specifically, as shown in FIGS. 13A and 13B, one or more pre-stored sequences 30a (e.g., previously stored trajectories) may be obtained from the storage unit 23 by the sequence generator 225 (t1). The acquisition of one or more sequences 30a may be performed by sampling at least one of the sequences 30-1 to 30-i in the dataset 10 either randomly or according to predefined criteria. According to an embodiment, the sequence 30a may be in the form of state-action pairs. Next, at least one branching state 30a-1 may be selected from the obtained sequence 30a either arbitrarily or as predefined (t2). Depending on the situation, the selected branching state 30a-1 may be used as the initial state for rollout. Sequentially, a skill corresponding to each of the selected branching state(s) 30a-1 (or subsequent branching states) may be sampled using the skill prior distribution p_θ(z|h), and a rollout in the latent space h: h_t for the skill may be performed using the flat dynamics model P_φ(h_{t+1}|h_t, z) (t3). As a result of the rollout, latent variables (e.g., the latent space h and the skill embedding z) are obtained. These latent variables may be converted into a virtual sequence 30-(i+1), such as a virtual trajectory of the original state-action pairs (s, a), using the state decoder D_φ and the skill decoder (i.e., the low-level policy) π\hat{ }L_θ(a_t|s_t, z) (t4). Consequently, one or more new sequences 30-(i+1) may be generated. The newly generated sequence(s) 30-(i+1) may be transmitted to the storage unit 23, as illustrated in FIGS. 12 and 13B, and added to the dataset 10 (t5).

The above-described operations of the skill obtainer 221 to the sequence generator 225 may be performed repeatedly at least once. That is, the skill-step model processing unit 220 may repeatedly generate one or more new sequences 30-(i+1) based on at least one of the pre-stored sequences 30-1 to 30-i and store them in the storage unit 23. The repeated generation of sequences 30-1 to 30-(i+1) may be initiated and/or terminated according to a selection or operation by a user or designer. According to an embodiment, the repeated generation of the sequences 30-1 to 30-(i+1) may be performed a predefined number of times, or may be terminated based on the number of sequences 30-1 to 30-(i+1) stored in the storage unit 23, or based on the number of newly generated sequences 30-(i+1).

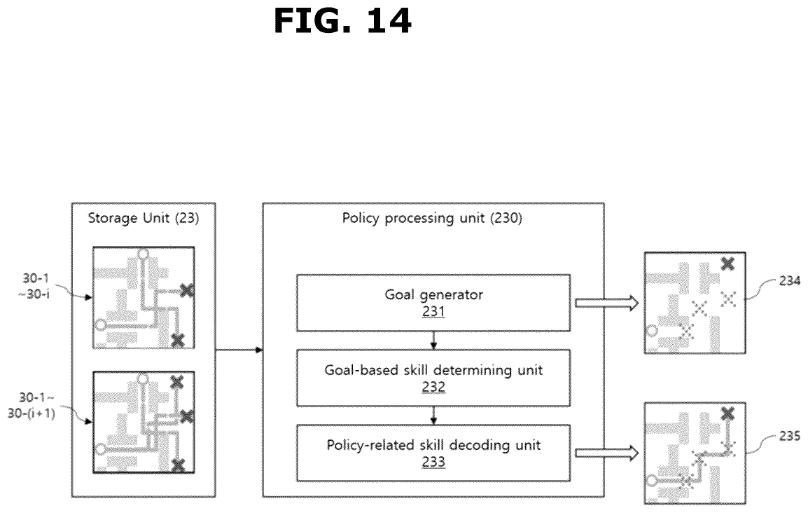

FIG. 14 is a block diagram of a policy processor according to an embodiment.

The policy processing unit 230 may perform skill-step goal-conditioned policy learning based on skills and may be configured to learn by decomposing the decision-making process into skill-level units. Referring to FIG. 14, in one embodiment, the policy processing unit 230 may include: a goal generator 231 for generating at least one sub-goal 234 (e.g., intermediate waypoints) to achieve a final goal (e.g., final destination) in a given state; a goal-based skill determining unit 232 for determining and acquiring at least one skill for achieving each sub-goal in the given state; and a policy-related skill decoding unit 233 for converting the acquired at least one skill into an action executable in a given environment. These components separate the policy decision-making process by sub-goal 234 and prevent the determination of sub-goals that are not achievable through the skill-step dynamics model, thereby enabling the policy learning device 20 to quickly adapt to the final goal.

When a final goal is set according to a predefined configuration or user input, the goal generator 231 may determine one or more intermediate steps, that is, one or more sub-goals 234, for achieving the final goal. In this case, the goal generator 231 may define the sub-goals 234 for the final goal either arbitrarily or based on a predefined configuration, and may further utilize a predetermined learning model for this purpose. The goal generator 231 may sample at least one sequence among the plurality of sequences 30-1 to 30-(i+1) stored in the storage unit 23, and may set a final goal based on the sampled sequence(s), and/or determine and set one or more sub-goals 234 corresponding to the final goal using the sampled sequence(s). In this case, the sampled sequence(s) may include a newly generated sequence 30-(i+1).

The goal-based skill determining unit 232 may receive at least one sub-goal 234 from the goal generator 231 and acquire a corresponding skill based on it. The determinator may acquire the skill for each sub-goal 234 by using an inverse skill-step dynamics model. Here, the inverse skill-step dynamics model is a model designed to infer a skill for a current state based on the current state and a subsequent state (i.e., current state+next state→skill), and may be implemented based on the aforementioned skill-step dynamics model. For example, the inverse skill-step dynamics model may be derived using the inverse transformation (or inverse function) of the previously described skill-step dynamics model.

The policy-related skill decoding unit 233 may determine one or more actions by decoding at least one skill acquired using the above-described inverse dynamics model.

According to one embodiment, the decoding may be performed using the skill decoder 223 described above, or another decoder that is identically replicated from the skill decoder 223, to decode the skill(s) corresponding to each sub-goal 234 and determine the corresponding action(s). In other words, the skill decoder 223 of the skill obtainer 221 may be used as-is or with partial modifications in the policy-related skill decoding unit 233. According to another embodiment, the policy-related skill decoding unit 233 may be implemented using a separate decoder trained independently from the skill decoder 223. In this case, the policy-related skill decoding unit 233 may be implemented using a decoder of a different type from the skill decoder 223 or the same type. The action(s) corresponding to each sub-goal 234 may be combined, and a sequence 235 (e.g., a path and associated actions) for achieving the final goal may thus be obtained.

Through this process, the policy processing unit 230 may acquire, train, update, and/or infer the skill-step goal-conditioned policy. According to an embodiment, the skill-step goal-conditioned policy may be stored in the storage unit 23 and may also be transmitted to the application unit 240 either simultaneously or at a different time.

The skill-step model processing unit 220 and the policy processing unit 230 of the above-described training unit 210 may be trained together. Hereinafter, their training process will be described in more detail.

Each component of the above-described training unit 210 needs to be optimally trained in order to determine sub-goals, determine corresponding actions, and determine the necessary skills to reach the most appropriate final goal. For example, at least one of the policy elements (e.g., the skill decoder 223, skill policy, and/or inverse dynamics model) and model components (e.g., dynamics model, skill encoder 222, skill prior distribution, state encoder E_θ, and/or state decoder D_φ) may need to be optimized jointly or sequentially. In this case, a loss function such as the one shown in Equation 9 below may be used for their optimization.

$$ℒ = {ℒ}_{skill} + {ℒ}_{prior} + {ℒ}_{model} + {ℒ}_{sg} \qquad [ Equation 9 ]$$

In Equation 9, L denotes the total loss function, L_skill refers to the loss function for the skill, and L_prior refers to the loss function for the skill prior distribution. In addition, L_model is the loss function for the model(s), and L_sg denotes the loss function for the skill-step goal loss. That is, rather than optimizing only one component (e.g., the skill), the goal-conditioned policy learning device 100 may be configured to optimize all or most of the policies and/or models together. According to an embodiment, at least one of the loss functions—L_skill for the skill, L_prior for the skill prior distribution, L_model for the model(s), and L_sg for the stop-gradient loss—may be omitted.

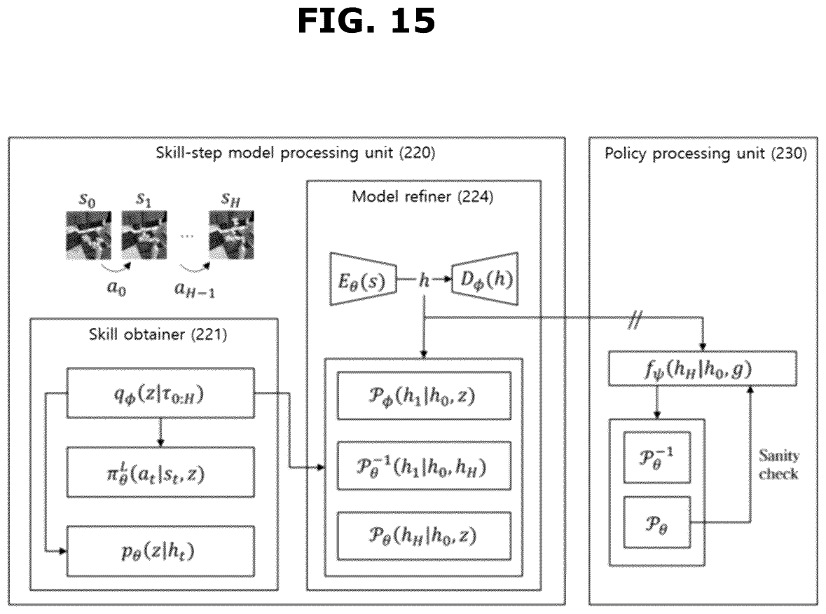

FIG. 15 is a diagram for describing a learning operation of a goal-conditioned policy learning device according to an embodiment.

As shown in FIG. 15, when a specific action a_0 is performed in a given state s_0, a new state s_1 is obtained in response. This process may be repeated, and a specific state s_H is reached upon performing a corresponding action a_(H−1). That is, through the execution of a total of H actions (a_0 to a_H), the state transitions from the initial state s_0 to a target state s_H.

In this case, as described above, the skill encoder 222 (q_ϕ(z|τ_0:H) of FIG. 15) may convert a sub-sequence τ_sub (e.g., a sub-trajectory), as given in Equation 8, into a corresponding skill embedding z using a conditional-β-VAE network. The skill decoder 223 (π\hat{ }L_θ(a_t|s_t, z) of FIG. 15) receives the skill embedding z from the skill encoder 222 and is configured to reconstruct the corresponding sub-sequence τ_sub from the provided skill embedding z. In this case, the skill encoder 222 and the skill decoder 223 may be optimized by a skill loss function L_skill, which may be defined as shown in Equation 10 below.

$${𝔼}_{{τ}^{sub} ∼ τ} [ {\sum }_{i = 0}^{H - 1} \underbrace{{( {π}_{θ}^{L} ( {s}_{i} , z ) - {a}_{i} )}^{2}}_{action reconstruction} + \underbrace{β \cdot KL ( {q}_{ϕ} ( z \vert {τ}^{sub} ) ‖ P ( z ) )}_{regularization} ] \qquad [ Equation 10 ]$$

In Equation 10, KL denotes the KL divergence, and P(z) refers to the skill prior distribution. Here, the skill prior distribution P(z) may be defined to follow a multivariate normal distribution with zero mean and an identity covariance matrix (i.e., P(z)˜N(0, l)). q_φ represents the skill encoding that transforms an action sequence into a skill embedding z, and π\hat{ }L_θ denotes the skill decoding that generates an action for a given state-skill pair. The skill encoder 123 may further be updated later through a model loss function L_model, which may be defined as shown in Equation 11 below.

$${𝔼}_{B ∼ 𝒟} [ {\sum }_{k = 0}^{H - 1} \underbrace{[ {( {D}_{ϕ} ( {h}_{t + k} ) - {s}_{t + k} )}^{2}}_{observation reconstruction} + \underbrace{{( {𝒫}_{ϕ} ( {h}_{t + k ,} z ) - {\overline{h}}_{t + k + 1} )}^{2} ]}_{flat dynamics} + \underbrace{{( {𝒫}_{0} ( {h}_{t} , z ) - {\overline{h}}_{t + H} )}^{2}}_{skill - step dynamics} + \underbrace{KL ( sg ( z ) ‖ {𝒫}_{θ}^{- 1} ( z \vert {h}_{t} , {h}_{t + H} ) )}_{inverse skill - step dynamics} ] \qquad [ Equation 11 ]$$

In Equation 11, h_t is defined as h_t=E_θ(s_t), and ⁻h_t is defined as ⁻h_t=E_⁻θ(s_t), where ⁻θ may be a slowly updated replica of θ. E_θ(s_t) denotes the processing performed by the state encoder. The variable z refers to the skill embedding, which may be computed by q_φ(τ\hat{ }sub) in Equation 9. As described in Equation 11, the skill encoding and the resulting skill embedding z may also be optimized through the same equation. As a result, the latent state space h∈H can be more tightly aligned with the skills, thereby facilitating seamless connections between sub-sequences of different sequences (e.g., sub-trajectories of distinct trajectories).

Meanwhile, the skill prior distribution p_θ(z|h_θ) may be obtained by optimizing a skill prior distribution loss L_prior, as defined in Equation 12 below, with respect to sub-sequences—e.g., sub-trajectories B={τ\hat{ }Sub_i}\hat{ }N_{i=1}—sampled from the dataset 10.

$${𝔼}_{B ∼ 𝒟} [ KL ( {p}_{θ} ( z \vert {h}_{t} ) ‖ sg ( {q}_{ϕ} ( z \vert {τ}^{sub} ) ) ) ] \qquad [ Equation 12 ]$$

In Equation 12, sg( ) denotes a stop-gradient function. h_t represents a latent state corresponding to a specific state s_t (e.g., s_0 being the first state) in the sub-trajectory τ\hat{ }sub, and may be given, for example, as h_t=sg(E_θ(s_t)). z denotes a skill embedding. As described above, the skill prior distribution p_θ(z|h_t) may be optimized based on the skill embedding z obtained by the skill encoder 222. As also mentioned above, the skill prior distribution p_θ(z|h_t) may be used to infer the distribution of executable candidate skills for a given latent state h_t, and may facilitate roll-out in the latent state space.

As described above, the dynamics model of the model refiner 224 may be optimized. For example, in order to enable roll-out in the latent state space, the state embedding (h of the model refiner 224 in FIG. 15), the skill-step dynamics model (P_θ(h_H|h_0, z) of FIG. 15), and the flat dynamics model (P_φ(h_1|h_0, z) of FIG. 15) may be jointly optimized. Here, the skill-step dynamics model P_θ(h_H|h_0, z), as illustrated in FIG. 15, may be configured to predict a next state from a current state through the overall execution of a skill, when the state encoder E_θ(s) encodes the states s_0, . . . , s_H into the state embedding space H, and the state decoder D_φ(h) reconstructs the states s_0, . . . , s_H. The model may be designed to utilize both the skill embedding z and the state embedding h. Additionally, the flat dynamics model P_φ(h_1|h_0, z) may be configured, under the same setting, to predict the next state's embedding by executing a given skill at a single time step, based on a given state embedding h and a skill embedding z. These models may be trained jointly using the model loss function L_model, as described in Equation 11. Specifically, the second term (denoted as flat dynamics) and the third term (denoted as skill-step dynamics) on the right-hand side of Equation 11 correspond respectively to the flat dynamics model P_φ(h_1|h_0, z) and the skill-step dynamics model P_θ(h_H|h_0, z). Moreover, the inverse skill-step dynamics model P \hat{ }−1_θ(h_1|h_0, h_H), as described in the last term (denoted as inverse skill-step dynamics) on the right-hand side of Equation 11, may also be trained jointly therewith.

Meanwhile, the policy π\hat{ }Z_ψ(a|s,g) of the policy processing unit 230 may include a low-level technology decoder π\hat{ }L_θ(a|s,z) and a high-level technology policy π\hat{ }Z_ψ(z|s,g) as shown in Equation 13 below.

$$π ( a \vert s , g ) = {π}_{θ}^{L} ( a \vert s , z ) ∘ {π}_{ψ}^{Z} ( z \vert s , g ) \qquad [ Equation 13 ]$$

In this case, in order to accelerate policy learning and adaptation, the skill policy may be decomposed as shown in Equation 14 below and used by the goal generator 231 and the goal-based skill determining unit 232.

$${π}_{ψ}^{Z} ( {s}_{t} , g ) = {𝒫}_{θ}^{- 1} ( z \vert {h}_{t} , {\hat{h}}_{t + H} ) ∘ {f}_{ψ} ( {\hat{h}}_{t + H} \vert {h}_{t} , g ) ∘ {E}_{θ} ( {h}_{t} \vert {s}_{t} ) \qquad [ Equation 14 ]$$

In Equation 14, f_ψ(\hat{ }h_t+H|h_t, g) corresponds to the operation of the goal generator 231, and P\hat{ }−1_θ(z|h_t, \hat{ }h_t+H) refers to the inverse skill-step dynamics model used by the goal-based skill determining unit 232. E_θ denotes the state encoder. As shown in Equation 14, the operation of the goal generator 231 and the inverse skill-step dynamics model-based processing may be separately modularized and sequentially executed. More specifically, with respect to the current state s_t and the long-term goal g, a skill step goal \hat{ }h_t+H is first inferred, and the corresponding skill embedding z is obtained through the inverse skill-step dynamics model P\hat{ }−1_θ(z|h_t, \hat{ }h_t+H). The skill decoder rπ\hat{ }L_θ may be trained according to Equation 10. According to an embodiment, the inverse skill-step dynamics model P\hat{ }−1_(z|h_t, \hat{ }h_t+H) may be trained using the model loss function L_model described in Equation 11. The adaptability of the inverse skill-step dynamics model depends on whether the environmental dynamics between the training dataset and the downstream task match. Therefore, for downstream tasks in which only the goal distribution is changed under the same environment, training and/or inference of actions for the goal can be achieved solely by updating the goal generator 231. This enables more efficient policy updates. According to an embodiment, the goal generator 231 may be optimized using the skill step goal loss function L_sg shown in Equation 15.

$${𝔼}_{B ∼ 𝒟} [ \underbrace{{( {\overline{h}}_{t + H} - {f}_{ψ} ( {h}_{t} , g ) )}^{2}}_{behavior cloning} + \underbrace{{( {f}_{ψ} ( {h}_{t} , g ) - {𝒫}_{θ} ( {h}_{t} , \hat{z} ) )}^{2}}_{sanity check} ] \qquad [ Equation 15 ]$$

In Equation 15, f_ψ(h_t, g) denotes a function representing the operation of the goal generator 231. In addition, ⁻h_t+H is defined as ⁻h_t+H=E_⁻θ(s_{t+H}), and \hat{ }z is defined as \hat{ }z˜P\hat{ }−1_θ(·|h_t, f_ψ(h_t, g)). In Equation 15, the first term corresponds to the error in behavior cloning (i.e., reproducing actions), and the second term corresponds to a sanity check that ensures consistency between the generated skill step goal and the actual outcome of skill execution. This sanity check verifies whether the inferred skill step goal aligns with the actual latent state reached through executing the corresponding skill.

The application unit 240 may apply the result processed by the training unit 210, that is, the skill step goal-conditioned policy, in an online setting, in order to derive an inference result desired by the user and/or to further perform learning based on the given skill step goal-conditioned policy. Additionally, if necessary, the application unit 240 may also perform verification of the skill step goal-conditioned policy.

FIG. 16 is a block diagram of a zero-shot processing unit according to an embodiment.

The zero-shot processing unit 250 is configured to handle downstream tasks involving different goal distributions in a zero-shot manner. As illustrated in FIG. 16, the zero-shot processing unit 250 may include a goal generator 251, a goal-based skill determinator 252, and a policy-related skill decoding unit 253. According to an embodiment, the components 251, 252, and 253 may be respectively configured to correspond to the goal generator 231, the goal-based skill determinator 232, and the policy-related skill decoding unit 233 of the policy processing unit 230. In other words, the zero-shot processing unit 250 may be implemented by duplicating or partially modifying the policy processing unit 230. The decoding unit 253 may output a sequence 254 corresponding to a given goal. Accordingly, even when a previously unseen goal is provided, the policy learning device 20 may determine actions (i.e., sequence 254) that align with the goal.

Here, the goal generator 251 may be tuned through reinforcement learning. In this case, the goal-based skill determinator 252 and the policy-related skill decoding unit 253 may employ the goal-based skill determinator 232 and the policy-related skill decoding unit 233 as they are. According to an embodiment, the goal generator 251 may be updated through value prediction-based reward maximization, and, if necessary, may also be updated through prior regularization and/or state consistency regularization. For example, the goal generator 251 may be optimized using a loss function given as the sum of reward maximization, prior regularization, and state consistency regularization, as shown in Equation 16 below.

$${𝔼}_{{B}^{′}} [ \underbrace{- Q ( {h}_{t} , {π}_{ψ}^{Z} ( {h}_{t} , g ) )}_{reward maximization} + α \cdot \underbrace{KL ( {π}_{ψ}^{Z} ( z \vert {h}_{t} , g ) ‖ {p}_{θ} ( z \vert {h}_{t} ) )}_{prior regularization} + \underbrace{{( {𝒫}_{θ} ( {h}_{t + H} \vert {h}_{t} , {π}_{ψ}^{Z} ( {h}_{t} , g ) ) - {f}_{ψ} ( {h}_{t + H} \vert {h}_{t} , g ) )}^{2}}_{state consistency regularization} ] \qquad [ Equation 16 ]$$

In Equation 16, h_t=sg(E_θ(s_t)). B′ may include skill-step transitions (s_t, z, s_t+H) collected online in a specific environment. The state consistency regularization strongly regulates the goal generator 251 (i.e., fψ(ht+H|ht, g)) for the purpose of reinforcement learning, thereby enabling the agent to reach the skill step target. In this case, as previously described, the components where θ and ϕ are used as parameters are not updated.

FIG. 17 is a block diagram of a few-shot processing unit according to an embodiment.

As illustrated in FIG. 17, the few-shot processing unit 260 may include a goal generator 261, a goal-based skill determining unit 262, and a policy-related skill decoding unit 263. The goal generator 261, the goal-based skill determining unit 262, and the policy-related skill decoding unit 263 may be the same as, or partially modified from, the goal generator 231, the goal-based skill determining unit 232, and the policy-related skill decoding unit 233 of the policy processing unit 230 described above. Even in the few-shot processing unit 260, only the goal generator 261 may be updated, while the goal-based skill determining unit 262 and the policy-related skill decoding unit 263 remain fixed. This may be optimized using Equation 16, either in the same or a slightly different manner. With this configuration, the few-shot processing unit 260 can determine a sequence 264 that corresponds to a given goal, even when learning has been previously performed based on only a small amount of data.

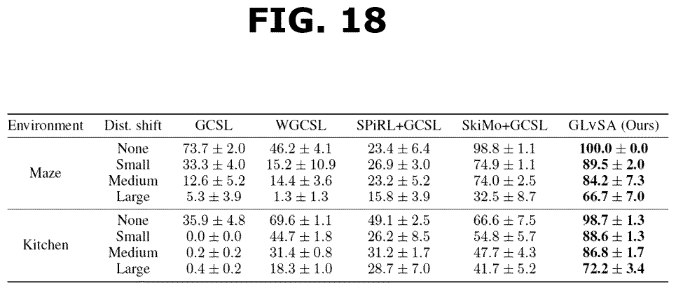

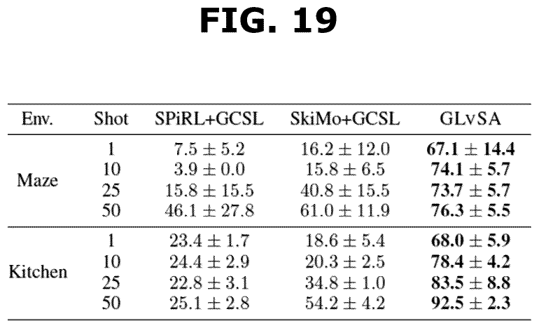

FIG. 18 is a diagram illustrating the zero-shot evaluation performance of the goal-conditioned policy learning device according to an embodiment, and FIG. 19 is a diagram illustrating the few-shot evaluation performance of the same device. FIGS. 18 and 19 visualize the experimental results obtained by evaluating various methods, including SPiRL (a skill-based reinforcement learning method), SkiMo (a hybrid of SPiRL and model-based reinforcement learning), and goal-conditioned reinforcement learning methods such as GCSL and WGCSL, as well as the proposed policy learning device 20, in two environments: Maze2D (an environment for reaching a goal by exploring a maze) and Franka Kitchen (an environment for manipulating objects in a kitchen). The performance of each model is expressed as a score ranging from 0 to 100, with a 95% confidence interval. In FIG. 18, “Dist. shift” refers to the distributional shift in the training data. In FIG. 19, “Shot” indicates the number of samples used for model fine-tuning.

Referring to FIG. 18, it can be seen that the policy learning device 20 (i.e., GLvSA) exhibits a clear zero-shot performance advantage over other models such as SkiMo and GCSL. Specifically, it shows a superiority of approximately 14.6 to 34.2 points in the Maze2D environment, and approximately 30.5 to 39.1 points in the Franka Kitchen environment.

Furthermore, as shown in FIG. 19, the policy learning device 20 (i.e., GLvSA) demonstrates a few-shot performance advantage over other models, such as SkiMo-showing superiority of approximately 15.3 to 58.3 points in the Maze2D environment and approximately 38.3 to 58.1 points in the Franka Kitchen environment. Notably, the policy learning device 20 maintains consistently strong performance even when provided with an extremely small number of samples, outperforming other comparative models.

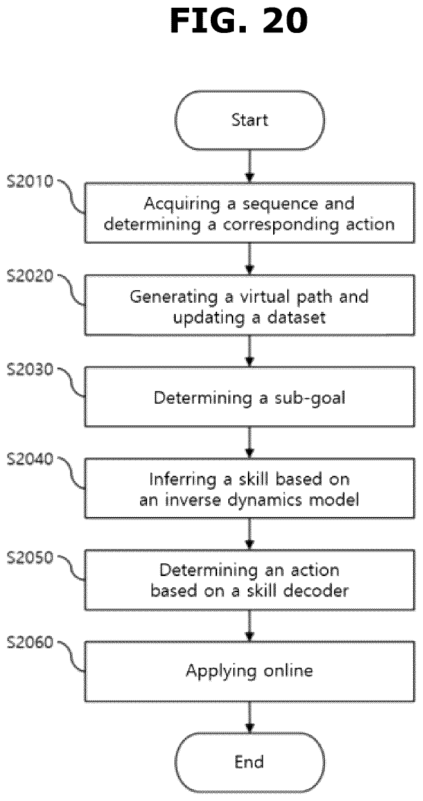

Hereinafter, an embodiment of the goal-conditioned policy learning method will be described with reference to FIG. 20.

FIG. 20 is a flowchart of a goal-conditioned policy learning method according to an embodiment.

Referring to FIG. 20, a series of actions corresponding to all or a portion of at least one sequence from a given dataset may be trained and/or determined (2010). Such action determination may be performed, for example, by encoding a skill based on all or part of the given sequence and decoding the action based on the encoded skill. The encoding of the skill may be performed by a skill encoder, and the decoding of the action from the skill may be performed by a skill decoder. Here, the skill encoder may further acquire the skill prior distribution.

Meanwhile, according to an embodiment, the skill-step dynamics model may be updated and refined through training in order to infer a skill required to achieve a goal or sub-goal. The skill-step dynamics model is a model configured to infer the next situation by combining the current situation and a skill, and may include at least one of a single-step dynamics model, a skill-step dynamics model, and an inverse skill-step dynamics model.

A virtual path may be generated (2020). The generation of a virtual path may be performed by sampling all or a portion of at least one sequence (e.g., at least one path), selecting at least one branch state from the sampled sequence(s), selecting a skill corresponding to each branch state based on the skill prior distribution, and performing roll-out at least once in the latent space using a refined dynamics model. As a result of the roll-out, the latent space and the corresponding skill embedding may be obtained, and these may be converted into a new sequence (which may be a virtual sequence, for example). The obtained new sequence may be added to the dataset, and accordingly, the dataset may be updated. If no dataset exists previously, the dataset may be newly generated based on the newly obtained sequence.

As described above, the virtual path generation process (2020) may be repeatedly performed according to an embodiment.

Meanwhile, for training the policy, a sub-goal for achieving the final goal may be determined according to a predefined value (2030).

Once a sub-goal is determined, a skill corresponding to the sub-goal may be inferred and obtained using the inverse skill-step dynamics model (2040). Here, the inverse dynamics model may be derived by applying an inverse transformation (or inverse function) to the above-described dynamics model, and may also be trained jointly with the dynamics model.

Once the skill corresponding to the given sub-goal is inferred, an action corresponding to the skill may be determined using a predetermined decoder (2050). Here, the predetermined decoder may include a skill decoder that decodes the encoded skill from a sequence to obtain the corresponding action.

The encoders, decoders, and policies used in the above-described processes (2010 to 2050) may be trained. The training may be performed offline, or online as needed.

The policy implemented through the sub-purpose generation and action determination processes (2030 to 2050) may be used for sequence inference and decision-making based on a newly given state or the like, or may be applied to zero-shot learning or few-shot learning for such inference and decision-making (2060). Zero-shot learning and few-shot learning may be performed either online or offline.

All or some of the above-described processes (2010 to 2060) may be performed in the same order as illustrated in FIG. 20, or may be performed in a different order, depending on the choice of a designer, user, or the specific circumstances. If necessary, all or some of the processes (2010 to 2060) may also be executed concurrently.

The goal-oriented policy learning method according to the above-described embodiment may be implemented in the form of a program executable by a computer device.

The program may include one or more of instructions, libraries, data files, and/or data structures, either alone or in combination, and may be designed and developed using machine-level code or high-level language code. The program may be specifically designed to implement the above-described method, or may be implemented using various known functions or definitions commonly available to those skilled in the field of computer software. The computer device may include, for example, a processor, memory, and optionally a communication unit for performing the functions of the program. The program for implementing the goal-oriented policy learning method may be recorded on a computer-readable recording medium. The computer-readable recording medium may include at least one type of physical storage medium capable of storing one or more programs either temporarily or permanently in a manner executable by a computer or similar device. Examples of such media include semiconductor memory devices such as ROM, RAM, SD cards, or flash memory (e.g., solid-state drives (SSDs)); magnetic disk storage media such as hard disks or floppy disks; optical recording media such as compact discs (CDs) or digital versatile discs (DVDs); and magneto-optical recording media such as floptical disks.

It will be understood by those of ordinary skill in the art to which the embodiments of the present invention pertain that various modifications may be made without departing from the essential characteristics of the present disclosure. Therefore, the disclosed methods should be regarded from a descriptive rather than a limiting perspective. The scope of the present invention is defined not by the foregoing detailed description but by the claims, and all variations equivalent in scope to the claims are to be construed as being included within the scope of the present invention.

What is claimed is:

1. A skill-based agent operation system, the system comprising:
a skill grounding device configured to select one or more executable candidate skills among a plurality of skills by semantically interpreting a user's natural language instruction;
and a goal-conditioned policy learning device configured to construct a skill sequence for achieving a goal based on the selected skill, and generate a goal-conditioned action policy by learning the constructed skill sequence based on reinforcement learning.

2. The skill-based agent operation system of claim 1,
wherein the skill grounding device comprises:
a skill generator configured to acquire an instruction and generate at least one skill according to the instruction;
a skill determinator configured to determine whether the at least one skill is executable; and
an instruction generator configured to generate a new instruction when it is determined that the skill is not executable,
wherein the skill generator generates at least one new skill based on the new instruction generated by the instruction generator.

3. The skill-based agent operation system of claim 2,
wherein the skill grounding device further comprises:
a hierarchical semantic skill database comprising at least one semantic skill, wherein the at least one semantic skill comprises a lower-level skill and an upper-level skill that are hierarchically configured, and
wherein the skill generator obtains at least one of an in-context example and a skill candidate group from the hierarchical semantic skill database, and generates the at least one skill using the at least one of the in-context example and the skill candidate group.

4. The skill-based agent operation system of claim 2,
wherein the skill determinator acquires environment information for a given environment using a visual-language model, and determines whether the skill is executable based on the environment information using a language model.

5. The skill-based agent operation system of claim 2,
wherein the instruction generator generates the new instruction using low-level skill semantic information belonging to an original semantic skill candidate group.

6. The skill-based agent operation system of claim 1,
wherein the goal-conditioned policy learning device comprises:
a storage configured to store a sequence; and
a processor configured to: determine at least one sub-goal corresponding to a final goal based on the sequence, acquire at least one skill corresponding to the sub-goal using an inverse skill-step dynamics model, and determine an action by decoding the at least one skill, wherein the inverse skill-step dynamics model comprises a model for inferring a skill based on a current situation and a next situation.

7. The skill-based agent operation system of claim 6,
wherein the processor is further configured to: generate a new sequence based on the sequence stored in the storage, and
acquire the new sequence by sampling at least one sequence from the storage,
select at least one branch state from the sampled sequence,
acquire a skill corresponding to each of the at least one branch state using a skill prior distribution,
acquire a latent space and a skill embedding based on at least one dynamics model, and
acquire at least one new sequence by performing decoding based on the latent space and the skill embedding.

8. The skill-based agent operation system of claim 7,
wherein the at least one dynamics model comprises a flat dynamics model for executing a skill under a single timestep to predict a state embedding for a next state in a current state, and
wherein the processor performs model refinement by optimizing the state embedding, the flat dynamics model, and a skill-step dynamics model together.

9. The skill-based agent operation system of claim 6,
wherein the processor comprises:
a skill encoder configured to encode all or a part of the sequence stored in the storage into a skill and obtain the skill prior distribution; and
a skill decoder configured to decode the skill and infer the action.

10. The skill-based agent operation system of claim 6,
wherein the processor is configured to train a skill-step dynamics model for inferring a next situation by combining a current situation and a skill, and wherein the inverse skill-step dynamics model is an inverse transformation of the skill-step dynamics model.

11. A skill-based agent operation method, the method comprising:
acquiring an instruction and generating at least one skill according to the instruction;
determining whether the at least one skill is executable;
generating a new instruction when it is determined that the skill is not executable; and
generating at least one new skill based on the new instruction.

12. The skill-based agent operation method of claim 11,
wherein the acquiring an instruction and generating at least one skill according to the instruction comprises:
obtaining at least one of an in-context example and a skill candidate group from the hierarchical semantic skill database; and
generating the at least one skill using the at least one of the in-context example and the skill candidate group,
wherein the hierarchical semantic skill database comprising at least one semantic skill, wherein the at least one semantic skill comprises a lower-level skill and an upper-level skill that are hierarchically configured.

13. The skill-based agent operation method of claim 11,
wherein the determining whether the at least one skill is executable comprises:
acquiring environment information for a given environment using a visual-language model; and
determining whether the skill is executable based on the environment information using a language model.

14. The skill-based agent operation method of claim 11,
wherein the generating at least one new skill based on the new instruction comprises:
generating the new instruction using low-level skill semantic information belonging to an original semantic skill candidate group.

15. A skill-based agent operation method, the method comprising:
determining at least one sub-goal corresponding to a final goal based on the sequence;
acquiring at least one skill corresponding to the sub-goal using an inverse skill-step dynamics model; and
determining an action by decoding the at least one skill, wherein the inverse skill-step dynamics model comprises a model for inferring a skill based on a current situation and a next situation.

16. The skill-based agent operation method of claim 15, further comprising:
generating a new sequence based on the sequence,
wherein the generating a new sequence based on the sequence comprises:
acquiring the new sequence by sampling at least one sequence;
selecting at least one branch state from the sampled sequence;
acquiring a skill corresponding to each of the at least one branch state using a skill prior distribution;
acquiring a latent space and a skill embedding based on at least one dynamics model; and
acquiring at least one new sequence by performing decoding based on the latent space and the skill embedding.

17. The skill-based agent operation method of claim 16, further comprising:
performing model refinement by optimizing the state embedding, the flat dynamics model, and a skill-step dynamics model together, and
wherein the flat dynamics model comprises a dynamics model for executing a skill under a single timestep to predict a state embedding for a next state in a current state.

18. The skill-based agent operation method of claim 15, further comprising:
encoding, by a skill encoder, all or a part of the sequence stored in the storage into a skill and obtaining the skill prior distribution; and
decoding, by a skill decoder, the skill and inferring the action.

19. The skill-based agent operation method of claim 15, further comprising:
training a skill-step dynamics model for inferring a next situation by combining a current situation and a skill,
wherein the inverse skill-step dynamics model is an inverse transformation of the skill-step dynamics model.
